(19) United States
(12) Patent Application Publication
(10) Pub. No.: US 2026/0236467 A1
(43) Pub. Date: Aug. 13, 2026

(54) VECTOR DATABASE LOOKUPS AND/OR INFERENCE

(71) Applicant: Intel Corporation, Santa Clara, CA (US)

(72) Inventors: Madhur KUMAR, Lucknow (IN); Sandeep Kumar, Bengaluru (IN); Sathvik Swaminathan, Bangalore (IN); Sreenivas Subramoney, Bangalore (IN)

(73) Assignee: Intel Corporation, Santa Clara, CA (US)

(21) Appl. No.: 19/632,239

(22) Filed: Mar. 28, 2026

(51) Int. Cl. G06F 16/2453; G06F 16/22

(52) U.S. Cl. CPC G06F 16/24542; G06F 16/2237; G06F 16/24539

(57) ABSTRACT

Techniques for vector database lookups and/or inference are described. An example of a system includes memory of a first type to store one or more of a machine learning model including at least a proper subset of a key-value (KV) cache and weights, a machine learning model memory manager, and/or a vector database search module; and memory of a second type to store one or more of at least a proper subset of the KV cache and weights of the machine learning model and/or the vector database, wherein the machine learning model memory manager is to determine and implement a memory split between the memory of the first type and the memory of the second type for the KV cache and weights of the machine learning model and the vector database search module is to perform an opportunistic, out-of-order vector database lookup upon receiving a vector database request.

### BACKGROUND

The last decade has witnessed a rapid rise in artificial intelligence (AI) based data processing, particularly based on deep neural networks (DNNs) such as large language models (LLMs). DNNs are widely used in the domains of computer vision, speech recognition, image, and video processing mainly due to their ability to achieve beyond human-level accuracy. A DNN typically includes a sequence of layers. A DNN layer may include one or more deep learning operations (also referred to as “neural network operations”), such as convolution operation, matrix multiplication operation, layer normalization operation, batch normalization operation, SoftMax operation, pooling operation, element-wise operation, linear operation, non-linear operation, and so on and during inference.

### BRIEF DESCRIPTION OF DRAWINGS

Various examples in accordance with the present disclosure will be described with reference to the drawings, in which:

FIG. 1 illustrates an exemplary large language model implemented as a transformer-based neural network, according to some embodiments of the disclosure.

FIG. 2 illustrates a serial transformer block, according to some embodiments of the disclosure.

FIG. 3 illustrates a parallel transformer block, according to some embodiments of the disclosure.

FIG. 4 illustrates an attention layer of a transformer block, according to some embodiments of the disclosure.

FIG. 5 illustrates computations in a self-attention layer without key-value (KV) caching, according to some embodiments of the disclosure.

FIG. 6 illustrates computations in a self-attention layer with KV caching, according to some embodiments of the disclosure.

FIG. 7 illustrates examples of a computing environment that supports one or more of opportunistic memory tiering and management of machine learning workloads and/or handling vector database (vectorDB) queries.

FIG. 8 illustrates examples of an ML model memory manager.

FIG. 9 is a graph illustrating the memory access characteristics and footprint requirements of a Large Language Model workload over the course of an inference session.

FIG. 10 illustrates examples of a specific snapshot of the memory state during the processing of a token sequence.

FIG. 11 is a block diagram illustrating the subsequent state of the memory contents.

FIG. 12 is a flow diagram illustrating examples of a method for managing memory in a machine learning model, specifically identifying operations for dynamically partitioning and migrating data between memory tiers.

FIG. 13 is a diagram illustrating a standard vector database lookup operation, provided to establish the context of serial dependencies inherent in conventional graph traversal algorithms.

FIG. 14 is a diagram illustrating examples of opportunistic memory tiering and out-of-order execution flow for vector database lookup.

FIG. 15 is a flow diagram illustrating examples of a method for performing a vector database lookup utilizing opportunistic memory tiering and out-of-order execution.

FIG. 16 illustrates an example computing system.

FIG. 17 illustrates a block diagram of an example processor and/or System on a Chip (SoC) that may have one or more cores and an integrated memory controller.

FIG. 18 is a block diagram illustrating a computing system 1800 configured to implement one or more aspects of the examples described herein.

FIGS. 19A-19C illustrate additional graphics multiprocessors, according to examples.

FIG. 20 shows a parallel compute system, according to some examples.

FIGS. 21A-21B illustrate a hybrid logical/physical view of a disaggregated parallel processor.

### DETAILED DESCRIPTION

The present disclosure relates to methods, apparatus, systems, and non-transitory computer-readable storage media for improving vector database lookups and/or inference.

Generative AI Models such as LLMs have taken the computing industry by storm. These models are armed with a gigantic number of parameters and exhibit exceptional state-of-the-art performance across various tasks. Current trends of LLM models are heading to scale of multi-trillion parameter models. According to one estimate, models are growing by 10× every 2 years. Current trajectory makes it practically impossible for smaller and medium players to operate and serve LLMs, and the sheer size of these models (one model requires 325 GB of memory simply to load its model weights) renders traditional optimization techniques like prefetching, dataflow, and caching completely ineffective. Furthermore, LLM during inference presents a tremendous challenge for the compute and memory resources (both bandwidth and capacity) for the platform. Additionally, the strict latency requirement (in the order of 50-100 ms), makes it more challenging to deliver high throughput while maintaining the latency.

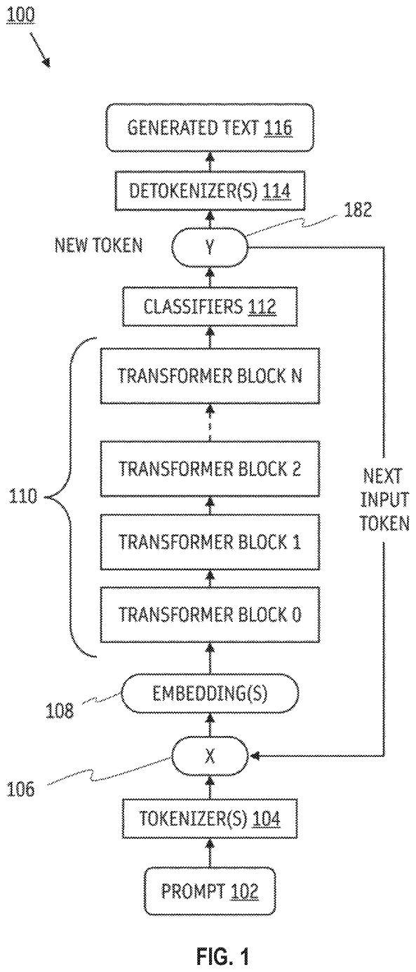

FIG. 1 illustrates an exemplary LLM 100 implemented as a transformer-based neural network, according to some embodiments of the disclosure. LLM 100 may include one or more components: tokenizer(s) 104, a stack of transformer blocks 110 (e.g., shown as transformer block 0, transformer block 1, transformer block 2, . . . . Transformer N), one or more classifiers 112, and detokenizer(s) 114. Tokenizer(s) 104 can break input data (e.g., prompt 102) into tokens. For example, prompt 102 may include text and tokenizer(s) 104 may break prompt 102 into sub-words. One or more tokens, represented as X 106, may be converted into embedding(s) 108, which includes high-dimensional input features for the stack of transformer blocks 110. The stack of transformer blocks 110 can acquire knowledge about the input data.

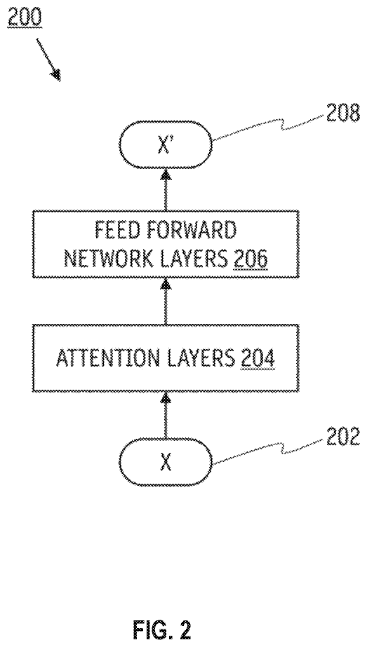

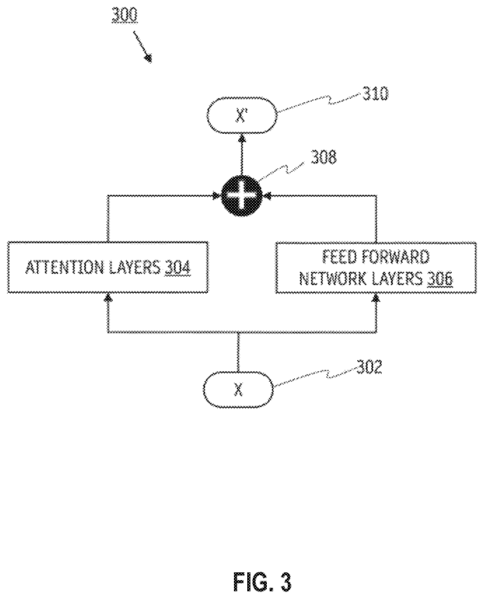

A transformer block in the stack of transformer blocks 110 can include two types of layers equipped with learning parameters: attention layers and feedforward (FFN) layers. One exemplary arrangement of a transformer block is illustrated in FIG. 2. Another exemplary arrangement of a transformer block is illustrated in FIG. 3. Attention layers allow the model to weigh the importance of tokens based on their contextual relevance and to capture their dependencies. Attention layers implement the attention mechanism of a transformer block, which captures contextual information by attending to positions within the sequences. FFN layers provide non-linear transformations to tokens independently.

One or more classifiers 112 can produce predictions or generate tokens based on the learned representations of the stack of transformer blocks 110. The tokens may be used by one or more detokenizer(s) 114 to produce generated text 116.

LLM 100 can serve as a framework for modeling complex relationships in text, images, audio, video, point clouds, graphs, etc. The number of learning parameters can be scaled up using the framework to model even more complex relationships.

LLM 100 is formulated to model sequential text in an autoregressive manner. Each subsequent token, shown as Y 182, is determined by the context of preceding tokens. During the training process of LLM 100, the transformer architecture is tasked to learn to predict the next token, Y 182, through slices of text with known succeeding tokens. Leveraging the abundance of text data available on the Internet, the size of transformers can be scaled up tremendously to hundred-billions of parameters. LLM 100 may be known as autoregressive transformer, causal transformer, decoder-only transformer, and decoding transformer. Subsequent alignment stage can make LLM 100 converse contextually and to human preference. A conversational LLM involving LLM 100 can be referred to as a Generative Pre-trained Transformer (GPT). Aligned LLMs may be known as instruction-tuned, instruction-following, and supervised fine-tuned LLMs.

Autoregressive modeling entails a sequential prediction during its deployment, hence LLM-based applications involve, by and large, text generation, outputting a token after token. The autoregressive nature of the model means engaging the whole model structures for every token prediction. Attributed to the vast number of model parameters (currently reaching scale of billions), the sequence inference is computationally demanding, characterized by an initial compute-intensive first prediction, followed by subsequent token-to-token predictions that are bottlenecked by memory bandwidth. The attention layers computation complexity is quadratic with the sequence length. Such complexity severely bottlenecks the performance especially for longer sequences.

FIG. 2 illustrates serial transformer block 200, according to some embodiments of the disclosure. Serial transformer block 200 includes attention layers 204, and FFN layers 206. An input, X 202, is first processed by attention layers 204, and the output of attention layers 204 is passed to FFN layers 206. FFN layers 206 may produce output, X′ 208. In some cases, serial transformer block 200 may include a skip connection that passes the input, X 202, to be added the output, X′ 210. Serial transformer block 200 may be implemented as one of the transformer blocks of the stack of transformer blocks 110 in FIG. 1.

FIG. 3 illustrates parallel transformer block 300, according to some embodiments of the disclosure. Parallel transformer block 300 includes attention layers 304, and FFN layers 306. An input, X 302, is processed by attention layers 304, and the input, X 302, is processed (in parallel) by FFN layers 306. The output of attention layers 304 and the output of FFN layers 306 are combined at adder 308. Adder 308 may produce a sum of its input, e.g., the output of attention layers 304 and the output of FFN layers 306. Adder 308 may produce a weighted sum of its inputs, e.g., the output of attention layers 304 and the output of FFN layers 306. Adder 308 may produce output, X′ 310. In some cases, parallel transformer block 300 may include a skip connection that passes the input, X 302, to be added to the output, X′ 310. Parallel transformer block 300 may be implemented as one of the transformer blocks of the stack of transformer blocks 110 in FIG. 1.

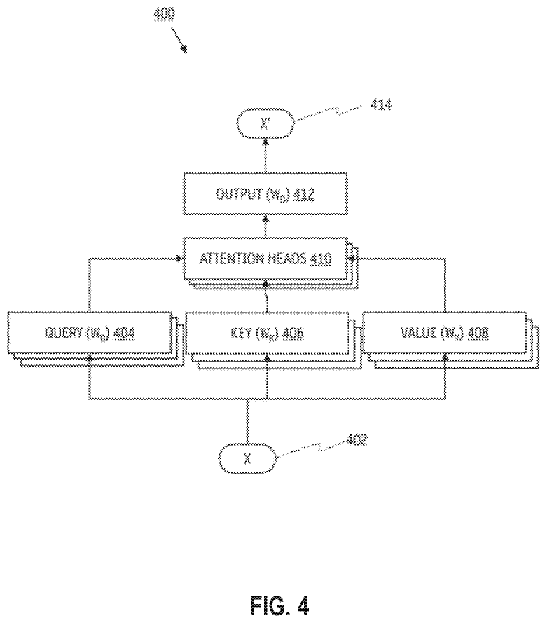

As illustrated in FIG. 1, transformer-based neural network models rely on encoder-decoder stacks with identical layers. As illustrated in FIGS. 2-3, each layer can have two key components: self-attention and feed-forward networks. Self-attention allows the model to analyze the entire sequence at once, but a single mechanism might miss nuances. Multi-head attention addresses this by creating multiple independent “heads” that focus on different aspects of word relationships. Multi-head attention mechanism is illustrated in FIG. 4. The outputs from these heads are combined for a richer understanding. Feedforward networks complement self-attention by introducing non-linearity, enabling the model to learn complex patterns. The number of layers stacked in the encoder and decoder (depth) and the number of heads within each layer (width) are hyperparameters. More layers and heads can enhance the model's ability to capture long-range dependencies but increase complexity. Heads and layers of various transformer blocks work together to give LLMs a nuanced grasp of text data, leading to superior performance natural language processing tasks.

FIG. 4 illustrates attention layer 400 of a transformer block, according to some embodiments of the disclosure. Attention layer 400 may be included as part of a transformer block in the stack of transformer blocks 110 in FIG. 1. As an example, attention layer 400 illustrates a multi-head attention layer having multiple attention head mechanisms. The input, X 402, be converted into queries (Q), keys (K), and values (V). Attention layer 400 includes parallel linear projections 404 of queries using the query weight matrix W_{Q}. Attention layer 400 includes parallel linear projections 406 of keys using the key weight matrix W_{K}. Attention layer 400 includes parallel linear projections 408 of values using the value weight matrix W_{V}. Results of linear projections are provided to parallel attention heads 410. An attention head 410 may apply an attention function using an output from one of the linear projections 404, an output from one of the linear projections 406, and an output from one of the linear projections 408. The attention function can be defined as:

$$Attention ( Q , K , V ) = SoftMax ( \frac{Q {K}^{T}}{{d}_{k}} ) V \qquad ( eq . 1 )$$

Q in equation 1 represents an output from one of the linear projections 404. K in equation 1 represents an output from one of the linear projections 406. V in equation 1 represents an output from one of the linear projections 408. dₖ represents a scaling factor. An attention head 410 may compute QK^{T}/dₖ to produce a matrix of raw attention scores based on the queries and keys. An attention head 410 may compute SoftMax

$$( \frac{Q {K}^{T}}{{d}_{k}} )$$

V to produce a matrix of attention weights, having a normalized matrix of the raw attention scores.

An attention head 410 may compute SoftMax

$$( \frac{Q {K}^{T}}{{d}_{k}} )$$

V to produce a final output where the attention weights are weighted by the values to form a final attended representation.

Outputs of parallel attention heads 410 may be concatenated together and passed to linear projection 412 using an output matrix W_{O}. The output of linear projection 412 is the output, X′ 414, of attention layer 400.

A linear projection used in attention layer 400 may include multiplying an input to the linear projection with a learned weight matrix. In some cases, the matrix multiplication is followed by an optional non-linearity, such as an activation function.

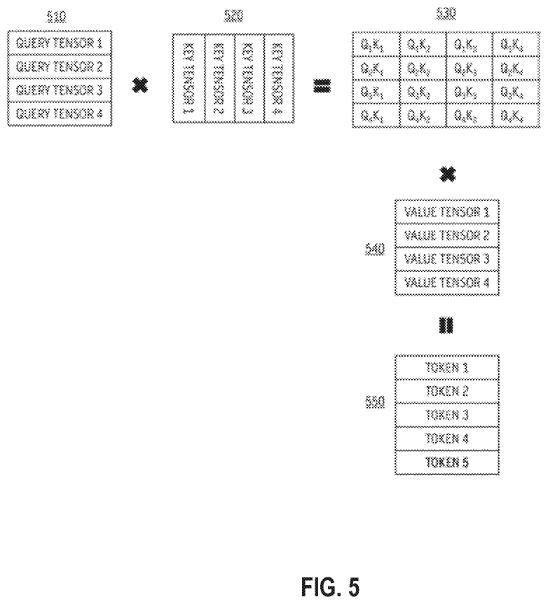

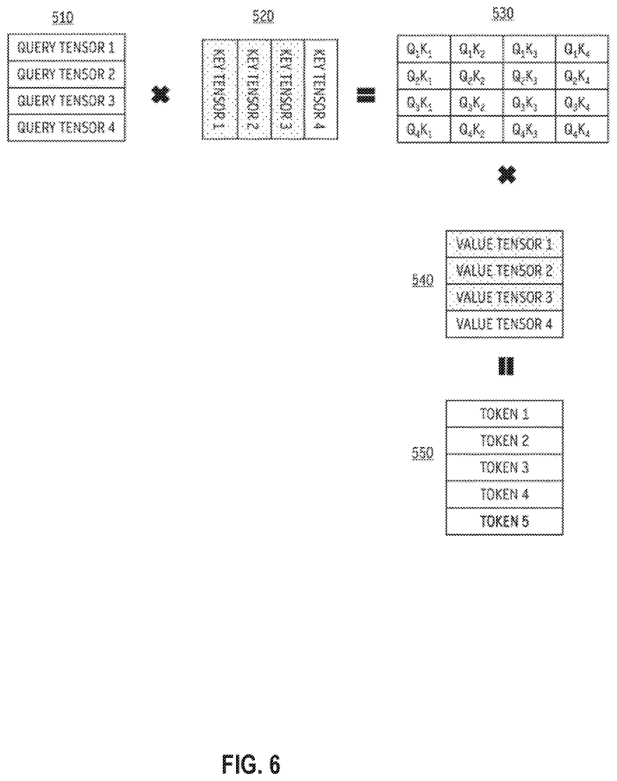

As discussed with FIG. 1, the attention mechanism in an autoregressive transformer-based model is a big bottleneck for performance for long sequences. A KV cache can be provided to store previously computed key tensors and value tensors from the attention mechanism and reuses the cached key tensors and value tensors for generating current tokens and thus avoids intensive recalculations of the key tensors and value tensors for previous tokens. KV caching became the de-facto optimization of the inference process to accelerate generation throughput for LLMs, allowing the attention operation to scale linearly rather than quadratically in the total sequence length. FIGS. 5 and 6 contrasts computations in an attention layer without KV caching and with KV caching.

### Understanding KV Caching and KV Cache Paging Schemes

FIG. 5 illustrates computations in a self-attention layer without KV caching, according to some embodiments of the disclosure. The self-attention layer may be part of a multi-head self-attention layer. In some embodiments, the self-attention layer is in a decoder of a transformer. In some embodiments, the self-attention layer may be in a transformer block, such as transformer blocks illustrated in FIG. 1. The computations in the self-attention layer may include multiplication of a query matrix 510 and a key matrix 520 (having one or more key tensors), which results in an attention weight matrix 530. The computations in the self-attention layer also include multiplication of the attention weight matrix 530 and a value matrix 540 (having one or more value tensors), which results in an output matrix 550 encoding new tokens, such as token 5. In some cases, output matrix 550 may include a context-aware attention representation that is weighted by value matrix 540. Output matrix 550 may be produced by the attention layer according to equation 1, using query matrix 510, key matrix 520, and value matrix 540, from which one or more new tokens can be generated. In other embodiments, the computations in the self-attention layer may include other computations, such as computations with a scaling function, SoftMax function, and so on. For the purpose of simplicity and illustration, these computations are not shown in FIG. 5.

Each of the query matrix 510, key matrix 520, and value matrix 540 may include a tensor (e.g., vector) for each of the tokens in the input sequence. For the purpose of illustration and simplicity, the input sequence has four tokens: tokens 1-4. The query matrix 510 may include four query tensors produced based on the four input tokens: query tensors 1-4. The key matrix 520 may include four key tensors: key tensors 1-4. The value matrix 540 may include four value tensors: value tensors 1-4. In the embodiments of FIG. 5, as the decoder does not implement KV caching, computations to produce the key tensors in the key matrix 520 and all the value tensors in the value matrix 540 need to be conducted. Some of the computations have already been conducted in the previous inference phase, e.g., computations to produce the key tensors 1-3 and computations on the value tensors 1-3. The duplication of these computations can be a waste of computational resources, such as power, time, and so on.

FIG. 6 illustrates computations in a self-attention layer with KV caching, according to some embodiments of the disclosure. Different from the embodiments of FIG. 5, the decoder in FIG. 6 implements KV caching. With KV caching, the key tensors and value tensors computed in the previous inference phase(s) (e.g., key tensors and value tensors corresponding to tokens 1-3) are cached in a KV cache and can be reused in the current inference phase. A KV cache stores previously computed key tensors and value tensors computed for one or more tokens in the attention mechanism and reuses them for generating the next attention output or token. In an implementation where distributed GPU workers are executing operations of a neural network, the KV cache can be allocated in GPU memory and contents of the KV cache can be loaded from CPU memory. In an implementation where a processor is executing operations of a neural network, the KV cache can be allocated in one or more memories local to the processor. The execution time scales more gracefully when KV caching is used as the sequence length increases. For instance, the generated intermediate KV tensors corresponding to previous tokens can be stored in a KV cache.

In the current inference phrase illustrated in FIG. 6, the cached key tensors and value tensors can be retrieved from a KV cache. Data that can be retrieved from the KV cache is highlighted with a dotted pattern in FIG. 6. Key tensors 1-3 may be retrieved from the KV cache. Value tensors 1-3 may be retrieved from the KV cache. In the current inference phase, the query matrix 510 can be multiplied with a concatenation of key tensor 4 and cached key tensors 1-3, followed by a SoftMax of the entire raw attention scores. The attention weights produced by performing SoftMax of the raw attention scores can be further multiplied with a concatenation of value tensor 4 and cached value tensors 1-3 to generate new results. After the inference is completed, key tensor 4 can be added to the KV cache. In some cases, the key tensors 1-3 can be updated in the KV cache. Also, value tensor 4 is added to the KV cache. In some cases, the value tensors 1-3 can be updated in the KV cache. This process is repeated per token. KV caching can reduce the number of computations in the self-attention layer. The amount of computation is reduced significantly when cached key tensors and value tensors can be reused to generate the next token. Therefore, computational resources can be saved. The performance and efficiency of the transformer model can be improved through KV caching.

When the KV cache is used, the previously computed key-value tensors are stored in memory (e.g., the KV cache) to avoid repetitive key-value projection computation in the attention mechanism, as illustrated in FIG. 6. The total memory footprint for a KV cache instance can be easily computed using equation 2:

$$Size = 2 \times precision \times {n}_{layers} \times {e}_{model} \times {L}_{s equence} \times B \qquad ( eq . 2 )$$

precision is the number of bytes per value stored (e.g., B for FP32), Players represents the number of layers in the model, d_{model} represents the dimensionality of the embeddings, L_{sequence} is the length of context in tokens, B is the batch size and the factor two is applied because two matrices for keys (K) and values (V) are needed.

As shown in equation 2, the KV cache size scales linearly with the (maximum) sequence length in the input context and the batch size. In practice, the size for the KV cache can be enormous. For example, a 175 billion parameters transformer-based model can consume around 325 GB of memory for storing the parameters. At the same time, at batch size 128 and sequence length 8K, the KV cache can have a size of around 4608 GB of memory, which is several orders of magnitude (12×) larger than the model weights themselves. Since the total sequence length cannot be known ahead of time, the KV cache memory requirements are therefore unknown, and this makes LLM memory management particularly challenging. Typically, the maximum sequence length (usually, 4K, and growing rapidly) is used for memory allocation to host the KV cache which leads to severely fragmented memory and very low batch size, and as a result, a low number of concurrent users for an LLM service is feasible.

The problem of the size of the KV cache is becoming increasingly prominent and is one of the key factors that makes LLM model deployment very costly. It is challenging to reduce KV cache memory footprints in LLMs without accuracy drops. With scaling sequence length becoming a critical demand for many companies, this makes limiting the context sequence inconceivable. The only design knob available for scaling a sizeable LLM deployment according to equation 2 is the batch size (B). Reducing batch size in effect reduces the model's throughput, which as a result severely degrades the total number of requests per second the model can serve.

KV cache paging schemes were introduced to improve memory management and increase serving model throughput. KV cache paging schemes manage attention key tensors and value tensors by dividing them into smaller, more manageable chunks, referred to herein as KV cache pages. The physical KV cache of a GPU worker is partitioned into fixed-sized blocks. The computed key tensors and value tensors can be organized as KV cache pages. A KV cache page can have (computed) key tensors and value tensors for a fixed number of tokens. KV cache pages may be copied into fixed-sized blocks of the physical KV cache of a GPU worker. KV cache paging schemes involve storing a KV cache page in a fixed-sized block in the physical KV cache of the GPU worker. KV cache pages having key tensors and value tensors corresponding to a sequence of tokens can be stored in non-contiguous fixed-sized blocks in the physical KV cache of the GPU worker. The GPU worker can be instructed, by instructions sent by a scheduler, e.g., implemented on a CPU, to retrieve the cached key tensors and value tensors of KV cache pages at the specific blocks in the physical KV cache when performing the attention computations to produce the next token. The GPU worker may be instructed to retrieve data from the KV cache based on the memory address provided by a KV cache manager. KV paging schemes are similar to virtual memory and paging in operating systems. When serving an LLM, a centralized scheduler (e.g., a CPU-based computing system) may manage the KV caches of distributed workers (e.g., GPU workers) and coordinate execution of requests by the distributed workers. Specifically, the centralized scheduler may control where KV cache pages are stored on the physical KV caches of the distributed workers. The centralized scheduler may coordinate swap-in and swap-out of KV cache pages and make cached key tensors and value tensors available to a distributed worker when the distributed worker is instructed to execute a request.

Generative artificial intelligence (GenAI) models such as LLMs have changed the computing landscape. LLM inference, where a trained model is used to generate output based on user query, has grown to be one of the most popular workloads to be run across multiple industries. The amount of memory required to train large models is growing at an alarming rate. Adding additional memory capacity is not a feasible solution, both technically (due to DRAM scaling challenges) and economically.

Traditional memory tiering solutions are application agnostic and fail to account for the deterministic but evolving memory access pattern of LLM inference workloads with weights remaining static, but the KV cache grows with each generated token. Traditional solutions are also “reactive,” relying on profiling to build a hotness profile, which is unsuitable for LLM inference where the generation of a token is in the order of milli seconds. Additionally, these solutions operate on a best-effort basis, using semi-accurate telemetry and sampling-based profiling that can misclassify hot pages as cold, degrading performance

Examples detailed herein describe a proactive memory tiering strategy tailored for LLM inference workloads. These examples leverage the bandwidth profiles of two key data structures, KV cache and model weights, and exploit the deterministic, layer-wise execution pattern of Transformer-based models to migrate these structures across memory tiers to extract the maximum fast memory bandwidth.

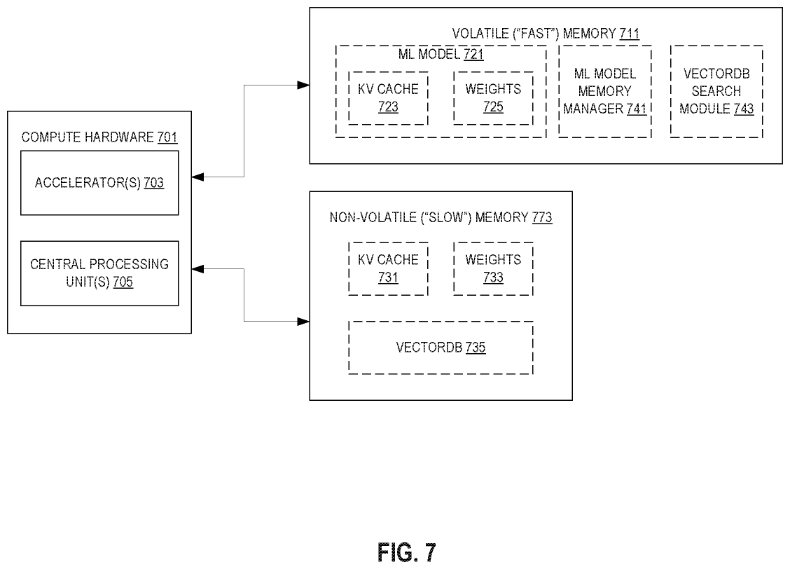

FIG. 7 illustrates examples of a computing environment that supports one or more of opportunistic memory tiering and management of machine learning workloads and/or handling vector database (vectorDB) queries. The computing environment includes compute hardware 701 coupled to a hierarchical memory subsystem that includes both one or more volatile “fast” memor(ies) 711 and one or more non-volatile or capacity-optimized “slow” memor(ies) 773.

The compute hardware 701 includes one or more accelerator(s) 703 and/or one or more central processing unit(s) 705. The accelerator(s) 703 are capable of performing parallelized arithmetic operations with high throughput. In various embodiments, the accelerator(s) 703 may be implemented as Graphics Processing Units (GPUs), Tensor Processing Units (TPUs), Neural Processing Units (NPUs), Field-Programmable Gate Arrays (FPGAs), Application Specific Integrated Circuits (ASICs), etc. These components are configured to execute one or more of matrix operations (e.g., matrix multiplications, manipulations, etc.), dot product calculations, and/or vector operations that may be sued in neural network inference and/or vector similarity searches. The accelerator(s) 703 typically possess high-bandwidth interfaces to communicate directly with the volatile “fast” memory 711 to minimize latency during active computation.

The central processing unit(s) (CPU(s)) 705 serve(s) as the host processor responsible for general-purpose computing tasks, system orchestration, and the execution of control logic. The CPU(s) 705 may manage the operating system, handles driver interactions for the accelerator(s) 703, and coordinates the flow of data between the storage devices and the memory hierarchy.

Furthermore, the central processing unit(s) 705 is/are may execute specific management modules, such as the machine learning (ML) model memory manager 741 and the vectorDB search module 743, which may reside in the volatile “fast” memory 711 during execution.

The memory hierarchy is bifurcated into tiers based on performance and capacity characteristics. The volatile “fast” memory 711 represents the highest tier of memory, characterized by low access latency and high data transfer bandwidth. In one embodiment, the volatile “fast” memory 711 is implemented using High Bandwidth Memory (HBM, HBM2e, or HBM3) co-packaged with the accelerator(s) 703, or high-performance Double Data Rate (DDR5) DRAM accessed via parallel memory channels.

The volatile “fast” memory 711 stores the working set of data that is immediately required for computation. This includes an active portion of an ML model 721 such as a KV cache 723 (or a portion thereof), which stores the key-value pairs associated with the active attention layers currently being processed or predicted to be processed in the immediate future. Similarly, the volatile “fast” memory 711 may also holds weights 725, which correspond to the model parameters of the active layers.

Conversely, the non-volatile “slow” memory 773 represents a capacity-tier memory or storage solution, characterized by higher latency and lower bandwidth relative to the volatile “fast” memory 711, but offering significantly larger storage capacity. In various embodiments, the non-volatile “slow” memory 773 is implemented using Compute Express Link (CXL) attached memory (e.g., Type 3 CXL devices), Non-Volatile Memory Express (NVMe) solid-state drives (SSDs), or a lower tier of DRAM that is physically distant from the compute hardware 701 (e.g., on a separate socket or expansion card). The non-volatile “slow” memory 773 serves as the backing store for the massive datasets required by modern AI workloads. It retains the portions of the machine learning data that are not currently in the active working set. This includes an inactive KV cache 731, representing attention history for tokens or layers that may not be currently involved in a computation, and inactive weights 733, representing parameters for model layers that are either already processed or not yet reached in the execution pipeline.

In some examples, the non-volatile “slow” memory 773 hosts a vectorDB 735, which contains the full repository of high-dimensional vector embeddings and associated graph index structures (e.g., Hierarchical Navigable Small World (HNSW) graphs) used for similarity search operations.

The ML model memory manager 741 is software or firmware logic that monitors the execution state of the ML workload. The ML model memory manager 741 determines a partitioning of the limited capacity of the volatile “fast” memory 711 between the KV cache 723 and the weights 725. The ML model memory manager 741 issues migration commands that preemptively move data from the KV cache 731 and weights 733 in the non-volatile “slow” memory 773 to the volatile “fast” memory 711 before the data is requested by the accelerator(s) 703 which may hide the access latency of the slower tier.

In some examples, a vectorDB search module 743 is executed in the volatile “fast” memory 711. The vectorDB search module 743 is used to performing vector database (e.g., vectorDB 735) lookups. The vectorDB search module 743 traverses the index structures of the vectorDB 735 and identifies candidate nodes in a vector graph that are likely to be visited. Based on this identification, the vectorDB search module 743 triggers the prefetching of neighbor nodes from the vectorDB 735 in the non-volatile “slow” memory 773 into the volatile “fast” memory 711. This allows the computationally intensive distance calculations (e.g., dot products) to be performed by the accelerator(s) 703 and/or CPU(s) 705 while neighbor nodes in “slow” memory 773 are prefetched.

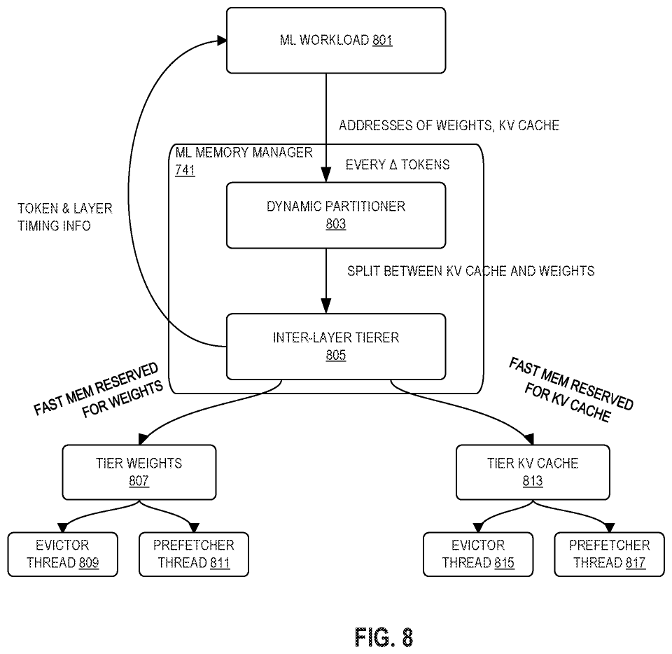

FIG. 8 illustrates examples of an ML model memory manager (e.g., ML model memory manager 741). The ML model memory manager 741 operates as a runtime controller that sits logically between execution hardware and the physical memory tiers. The ML model memory manager 741 intercepts, analyzes, and acts upon memory access characteristics generated by an ML workload 801. In some examples, the ML workload 801 represents the execution of a large language model, such as a Transformer-based neural network such as a large language model, which generates a predictable yet resource-intensive stream of memory references. As the ML workload 801 processes inference requests, it generates addresses of weights and KV cache entries required for computation. The ML model memory manager 741 receives these addresses, along with auxiliary metadata such as token identifiers and layer timing information, to make decisions regarding data placement in “fast” memory 711 or “slow” memory 773. By monitoring the execution progress of the LLM workload 801, the ML model memory manager 741 predicts future memory requirements with high accuracy, given the deterministic nature of neural network usage.

The ML model memory manager 741 includes a dynamic partitioner 803 that determines an allocation of the limited volatile “fast” memory 711 resources between two competing data types: the model weights, which are generally static and read-only during inference, and the KV cache, which is dynamic and grows linearly with the sequence length.

The total bandwidth driven from fast memory is due to weights and KV-caches access. At the time of inferencing token t, it can be written as

$${BW}_{total}^{t} = {BW}_{W}^{t} + {BW}_{KV}^{t}$$

The bandwidth depends on the size occupied by the weights and KV-cache entries.

$${BW}_{W} ∝ {sz}_{W}^{t} {BW}_{KV}^{′} ∝ {sz}_{KV}^{t}$$

Using the best curve, this establishes a relationship for mₖᵥ and m_{w} as below and the corresponding bandwidth.

| | | |
|---|---|---|
| Rate of change | ${m}_{W} = - {K}_{2} * {( {sz}_{W}^{t} )}^{2} + {K}_{1} * {sz}_{W}^{t} + {K}_{0}$ | ${m}_{KV} = k * BS * {sz}_{KV}^{t}$ |
| Final Bandwidth | ${BW}_{W}^{t} = {m}_{W} * t = ( - {K}_{2} * {( {sz}_{W}^{t} )}^{2} + {K}_{1} * {sz}_{W}^{t} + {K}_{0} ) * t$ | ${BW}_{KV}^{t} = {m}_{KV} * t = k * BS * {sz}_{KV}^{t} * t$ |

For the weights, the first negative term captures the decrease in driven bandwidth with each generated token (t) due to an increase in the latency of the multi-head attention (MHA) kernel (accessing KV cache) causing delays between successive accesses to the weights. However, the second positive term captures the positive correlation between driven bandwidth and size of Weights in the fast memory.

If the size of fast memory is fixed (say SZ_{fmem}), then using

$${sz}_{W}^{t} ∝ {SZ}_{fmem} - {sz}_{KV}^{t}$$

Equation 1 can be simplified to:

$$B {W}_{t otal}^{t} = ( {A ( {sz}_{KV}^{t} )}^{2} + B s {z}_{K V}^{t} + C ) * t$$

Constants A, B, C are combinations k, K₀, K₁, K₂ BS, and SZ_{fmem} which gives an optimization problem that can be solved with different techniques

$${maximize}_{{sz}_{KV}^{t}} ( {A ( s {z}_{KV}^{t} )}^{2} + {Bsz}_{KV}^{t} + C ) * t$$

$$subject to {sz}_{KV}^{t} \leq {size}_{total}^{KV} ; {sz}_{KV}^{t} \leq {SZ}_{fmem}$$

The dynamic partitioner 803 receives inputs regarding the current token count and layer execution timing. In one embodiment, the dynamic partitioner 803 is configured to re-evaluate the memory allocation strategy at specified interval of one or more tokens being processed (shows as delta tokens in the illustration). In examples where the partitioning is determined after a plurality of tokens excessive thrashing that might occur if the partition were adjusted for every single token may be prevented, while ensuring the system remains responsive to the accumulation of context data. The dynamic partitioner 803 calculates a memory split between the KV cache and the weights. For example, as the sequence length increases (and thus the KV cache footprint expands), the dynamic partitioner 803 may determine that a larger percentage of the volatile “fast” memory 711 must be reserved for the KV cache to prevent latency-inducing misses, thereby necessitating the eviction of a corresponding volume of weights to the non-volatile “slow” memory 773. In some examples, the dynamic partitioner 803 is aware of the total amount of “fast” memory 711 that is available for weights and KV cache. In some examples, the dynamic partitioner 803 considers the latency of moving data into and/or out of a “fast” memory 711.

Based on the split ratio and boundaries determined by the dynamic partitioner 803 an inter-layer tierer 805 translates the higher-level allocation policy into concrete data movement operations. The inter-layer tierer 805 receives the specific capacity limits (e.g., the indicated “reserved” values in the figure) and coordinates the migration of data layers. Note that the migration is asynchronous in some examples. In some examples, weights and/or KV cache values are migrated according to a sliding window (e.g., as a layer complete the “fast” memory 711 allocated to that layer is freed and the weights 807 either migrated to “slow” memory 773 (if not copied) or marked as invalid to be evicted (if a copy exists in “slow” memory 773).

The inter-layer tierer 805 maintains a global view of the model's execution graph, tracking which layers are currently active, which have been completed, and which are upcoming. By synchronizing this graph view with the determined memory split, the inter-layer tierer 805 issues distinct commands to handle the specific characteristics of weights and cache data, respectively.

To manage the static model parameters (weights), the inter-layer tierer 805 controls a tier weights module 807. The tier weights module 807 is specifically optimized for handling large, contiguous blocks of values associated with model layers (e.g., feed forward network matrices, attention projection matrices, etc.). The tier weights module 807 instantiates and manages an evictor thread 809 which identifies weight pages that correspond to layers that the ML workload 801 has already processed for the current token generation step. Once a layer is architecturally “past,” the evictor thread 809 triggers the demotion of these weights from the volatile “fast” memory 711 to the non-volatile “slow” memory 773 or simply discards them if a clean copy already exists in the slow tier, thereby freeing up valuable high-speed capacity. A prefetcher thread 811 operates to look ahead in the execution graph. The prefetcher thread 811 identifies the weights associated with the next set of layers to be computed and issues copy command (e.g., a Direct Memory Access (DMA) or Data Streaming Accelerator (DSA) request) to copy these weights from the non-volatile “slow” memory 773 into the space freed by the evictor thread 809.

A tier KV cache module 813 handles the dynamic state of the model. Unlike weights, the KV cache consists of data that is written to during the processing of each token and read from during the processing of subsequent tokens. The tier KV cache module 813 employs an evictor thread 815 configured to manage the lifecycle of attention keys and values. When the dynamic partitioner 803 signals that the “fast” memory 711 allocated to the KV cache is full, or when specific attention heads are no longer active for the current window of computation, the evictor thread 815 identifies the appropriate cache blocks (e.g., those corresponding to the earliest tokens in a long sequence) and migrates them to the non-volatile “slow” memory 773. Conversely, the prefetcher thread 817 is tasked with retrieving these stored KV pairs when the attention mechanism requires them for computing attention scores against the history. By effectively utilizing separate threads—the evictor thread 809, prefetcher thread 811, evictor thread 815, and prefetcher thread 817—the system decouples memory management overhead from the inference latency, ensuring that the necessary data is resident in the volatile “fast” memory 711 when the compute hardware requires it.

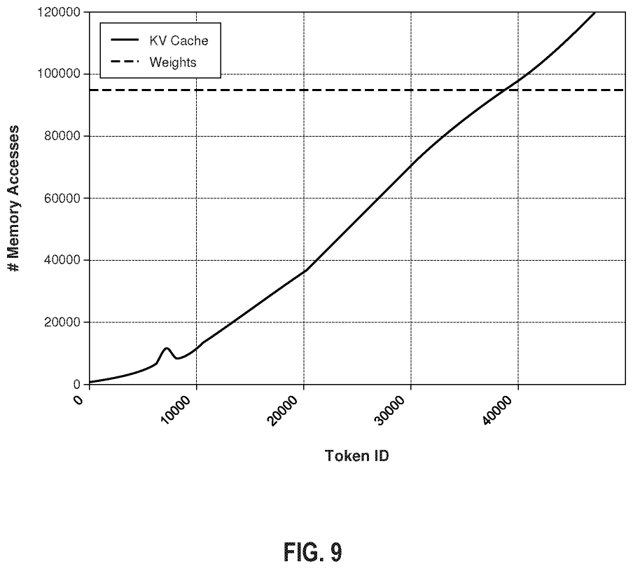

FIG. 9 is a graph illustrating the memory access characteristics and footprint requirements of a Large Language Model workload over the course of an inference session. This illustrates that as more tokens are processed the KV cache grows while the size of memory needed weights for a given layer stays static because the weight matrices (e.g., for Feed Forward Networks and attention mechanisms) are static architectural components of the pre-trained model 721 and do not change size as the sequence grows. Conversely, the solid line, labeled “KV Cache,” demonstrates an approximately linear growth pattern. As the Token ID increases, the context window expands, and the system must store Key-Value pairs for every preceding token to compute attention scores for subsequent tokens. The intersection of the “KV Cache” line with the “Weights” line and the point where the sum of these two curves approaches the physical capacity limit of the volatile “fast” memory 711 (represented by the horizontal capacity threshold), necessitates the active intervention of the tiering logic. The graph underscores that while the weights are static in size, their large base footprint combined with the monotonically increasing KV cache eventually exceeds the high-speed memory capacity, requiring the dynamic partitioning and swapping mechanisms described herein.

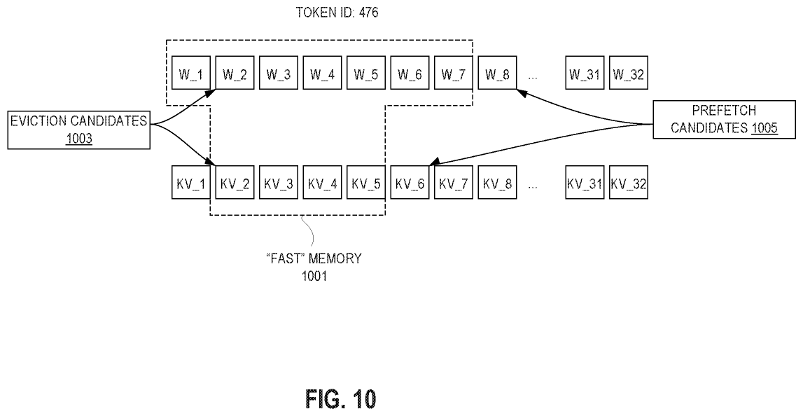

FIG. 10 illustrates examples of a specific snapshot of the memory state during the processing of a token sequence. In this example, a token having a “Token ID: 476” is being processed. In this state, the volatile “fast” memory 1001 (which corresponds to the fast memory 711 of FIG. 7) functions as a sliding execution window. It does not hold the entire model or the entire KV history or weights; rather, it contains only the subset of data necessary for the immediate computational steps and potentially subsequent computation steps (e.g., weights for subsequent layers, etc.). The volatile “fast” memory 901 is depicted holding a contiguous range of active weights (W_3 through W_8) and KV cache blocks (KV_3 through KV_8). These blocks correspond to the specific layers of the neural network that the compute hardware 701 is currently executing or is about to execute. For example, if the accelerator 703 is currently performing matrix multiplications for Layer 5 (associated with W_5 and KV_5), the system ensures that Layer 5, along with its immediate neighbors (Layers 3-4 and Layers 6-8) for buffering, are resident in the fast memory domain.

The diagram also illustrates the identification of candidates for data movement, a process managed by the inter-layer tierer 805. To the left of the active window, the system identifies eviction candidates 1003. These candidates include weights (e.g., W_1 and W_2) and KV cache entries (e.g., KV_1 and KV_2) associated with layers that have already been processed for the current token generation step. Because the forward propagation of the neural network is sequential (e.g., Layer 1 output feeds Layer 2), once Layer 1 is computed, its weights W_1 are not required again until the processing of the *next* token begins. Therefore, the evictor threads 809/815 designate these blocks for demotion to the non-volatile “slow” memory 773. To the right of the active window, the system identifies prefetch candidates 1005. These candidates include weights (e.g., W_31, W_32) and KV cache entries (e.g., KV_31, KV_32) associated with future layers that are deeper in the neural network architecture. The prefetcher threads 811/817 proactively retrieve these blocks from the non-volatile “slow” memory 773, scheduling their arrival in the volatile “fast” memory 1001 to coincide with the completion of the current layers, thereby effectively hiding the transfer latency.

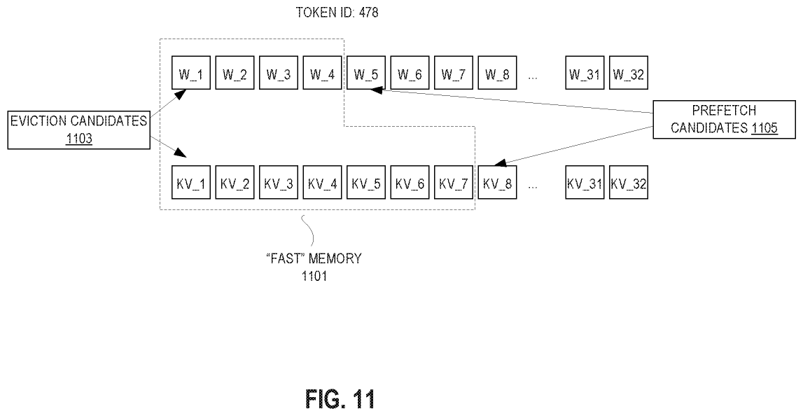

FIG. 11 is a block diagram illustrating the subsequent state of the memory contents at “Token ID: 478,” demonstrating the temporal progression of the sliding window mechanism, in accordance with one embodiment. Compared to FIG. 10, the execution of the model has advanced by two tokens (or alternatively, the processing within the single token generation has advanced by two layers, depending on the granularity of the view). The volatile “fast” memory 1101 now contains a shifted set of data blocks. The sets of candidates have been updated to reflect this new state. The system has identified KV cache has needed to grow at the expense of the weights.

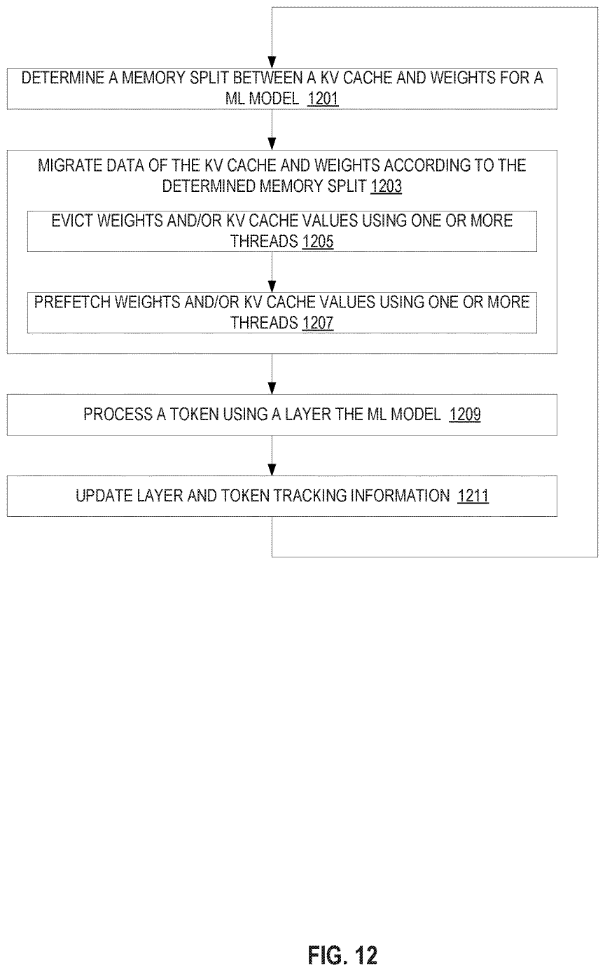

FIG. 12 is a flow diagram illustrating examples of a method for managing memory in a machine learning model, specifically identifying operations for dynamically partitioning and migrating data between memory tiers. This depicts acts performed by at least the ML model memory manager 741 to orchestrate the movement of model parameters and transient state data between the volatile “fast” memory 711 and the non-volatile “slow” memory 773 and the processing of tokens by an ML workload.

At 1201, a determination of a memory split between a KV cache and weights for an ML model. This operation is performed by the dynamic partitioner 803 in some examples, which continuously monitors the execution state of the ML workload 801. To determine the optimal split, the dynamic partitioner 803 first analyzes the current token count and the associated sequence length. Because the memory footprint of the KV cache 723 grows with the number of tokens processed, the dynamic partitioner 803 calculates the capacity required to store the key-value pairs for the current context window. This calculation involves multiplying the current sequence length by the model's hidden dimension size, the number of attention heads, and the precision (e.g., FP8, FP16, FP32, INT4, INT8, INT16, etc.) of the stored values. The dynamic partitioner 803 also evaluates the fixed memory requirement for the active weights 725. Based on the total available capacity of the volatile “fast” memory 711, the dynamic partitioner 803 effectively subtracts the growing requirement of the KV cache 723 to determine the remaining headroom available for weights. If the KV cache 723 demands a larger proportion of the fast memory, the determined split shifts the boundary, reducing the allocation for resident weights and thereby forcing a more aggressive tiering strategy where fewer weight layers are kept resident simultaneously. This determination may be triggered at configurable intervals, such as every delta tokens, to prevent excessive re-partitioning overhead while ensuring the memory layout adapts to the expanding context.

At operation 1203, the ML model memory manager 741 migrates data of the KV cache and weights according to the determined split. Upon establishing the new partition ratio, the ML model memory manager 741, specifically through the inter-layer tierer 805, translates the abstract memory split into concrete data placement commands. This involves mapping the logical layer identifiers of the ML model 721 to physical address ranges within the volatile “fast” memory 711. The inter-layer tierer 805 identifies which layers currently reside in the fast tier and compares this residence map against the newly calculated split and the current execution position in the neural network graph. If the new split dictates that the resident set of weights must shrink to accommodate KV growth, the inter-layer tierer 805 schedules the necessary migration tasks. This operation effectively redefines the boundaries of the sliding window, determining exactly which subset of the model's hundreds of layers is authorized to occupy the high-bandwidth memory at any given microsecond. The migration logic ensures that the reconfiguration of the memory layout occurs coherently, preventing the overwriting of active data before it has been successfully processed or preserved.

At 1205, evicts weights and/or KV cache values are evicted according to the memory split using one or more threads. This operation is executed by the evictor thread 809 for weights and the evictor thread 815 for the KV cache to clear space in the volatile “fast” memory 711 for incoming data. Regarding the weights, the evictor thread 809 scans the execution graph to identify layers that the compute hardware 701 has fully processed for the current token generation step. Once a layer's computation is complete (e.g., the matrix multiplication for a layer is finished), the weights associated with the layer are no longer needed until the next token. Consequently, the evictor thread 809 marks the corresponding memory pages as available for reuse. If the weights in the fast tier are unmodified copies of the data in the non-volatile “slow” memory 773, the eviction may simply involve invalidating the fast memory mapping; however, if localized updates have occurred, the thread manages the write-back process. Similarly, regarding the KV cache, the evictor thread 815 identifies attention history blocks that fall outside the current fast-memory window. For extremely long sequences, older KV pairs may be demoted to the non-volatile “slow” memory 773 to prioritize the most recent context nodes.

At 1207, weights and/or KV cache values are prefetched using one or more threads. Concurrent with the eviction process, the prefetcher thread 811 and prefetcher thread 817 proactively retrieve data from the non-volatile “slow” memory 773 into the volatile “fast” memory 711. This operation is critical for hiding the higher latency of the capacity tier (e.g., CXL or SSD). The prefetcher thread 811 analyzes the model's execution trajectory to identify the specific weight matrices required for the upcoming layers (e.g., Layers N+1, N+2). The prefetcher thread 817 retrieves necessary KV cache history from the slow tier if the attention mechanism predicts a need to attend to distant tokens that were previously swapped out.

At 1209, a token using a layer of the ML model as a part of an ML workload. With the requisite data staged in the volatile “fast” memory 711, the compute hardware 701 (e.g., the accelerator 703) executes the mathematical operations defined by the ML model 721. This involves reading the active weights 725 and the active KV cache 723 directly from the high-bandwidth media to perform dense matrix multiplications and attention score calculations. The processing generates output activations which are then passed to the subsequent layer or utilized to determine the probability distribution for the next token in the sequence.

At 1211, layer and token tracking information are updated and ready for use in determining a next. Following the processing of a layer or a full token, the ML model memory manager 741 updates its internal state to reflect the progress of the inference workload. This includes incrementing the global token count, advancing the pointer for the currently active layer, and recording timing metrics related to memory transfer latencies and compute duration. This updated tracking information is fed back into the dynamic partitioner 803 and the inter-layer tierer 805. For example, the incremented token count serves as the input for the next iteration of operation 1201, triggering a re-evaluation of the memory split if the delta token threshold is reached. By continuously closing this feedback loop, the system dynamically adapts the memory tiering strategy in real-time, responding to the evolving computational characteristics of the model as the sequence length increases. The method then iterates, repeating the cycle of determining splits, migrating, evicting, prefetching, and processing for subsequent tokens and layers.

High performance, low-latency vector databases (vectorDBs) are key to many AI workloads to enable a fast and scalable look up of high-dimensional embeddings. An example is Retrieval Augmented Generation (RAG), where GenAI (e.g., LLM) modes fetch relevant information from a VectorDB to generate accurate and more up-to-date information without expensive re-training. A major operation in a VectorDB search operation is a dot product of many high dimensional vectors. Typically, these dot products must be performed at a fast rate to meet the strict low-latency service level agreement (SLA). To meet the SLA, the vectors must be accessed from a fast memory technology. However, doing so requires an enormous amount of fast memory.

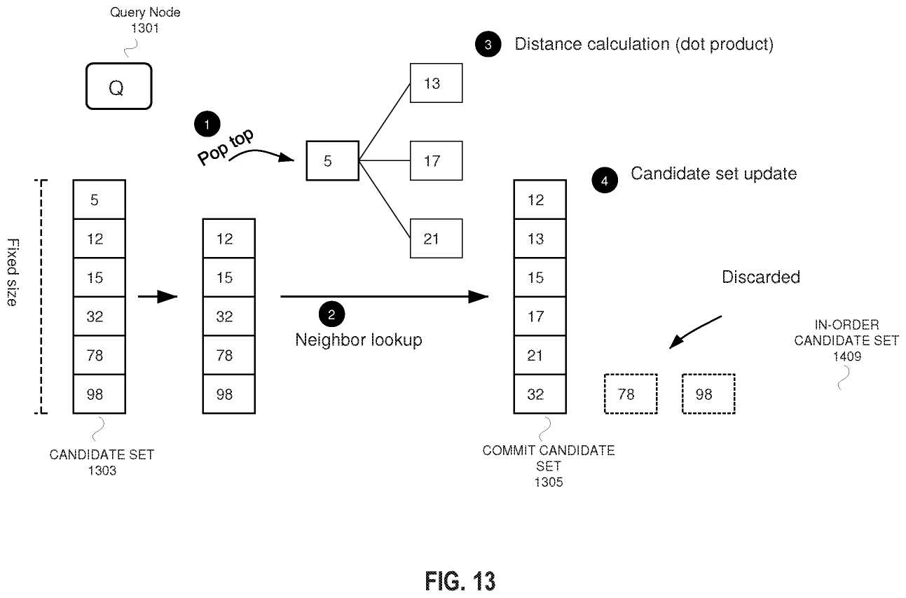

FIG. 13 is a diagram illustrating a standard vector database lookup operation, provided to establish the context of serial dependencies inherent in conventional graph traversal algorithms. In a typical implementation utilizing HNSW graphs or similar indexing structures, the search process is strictly sequential. A query node 1301, representing the vector embedding of a user request (e.g., a text prompt or image feature vector), serves as the reference point for similarity calculations. The search algorithm maintains a candidate set 1303, effectively a priority queue of fixed size, which holds the graph nodes identified as potential nearest neighbors that require further exploration. In this conventional flow, the system must perform a specific sequence of operations for the top-ranked element before it can proceed to the next. Specifically, the system pops the top element (e.g., node 5) from the candidate set 1303 (circle 1). A candidate set is a priority queue of vectors whose neighbors are likely to be explored next. Elements at the top of the candidate set get processed sooner than elements further down. So, neighbors of elements down the candidate are appropriate for migrating to fast tier during vector search.

Only after this node is removed can the system access the graph structure to identify its neighbors (e.g., nodes 13, 17, 21) (circle 2). Subsequently, the system must retrieve the high-dimensional vector data for these neighbor nodes from memory to perform distance calculations, such as dot products or Euclidean distance computations, against the query node 1301 (circle 3). Finally, based on these calculated distances, the system updates the candidate set 1303, inserting better candidates and discarding the worst nodes (e.g., nodes 78 and 98) to maintain the fixed size constraint (circle 4). This serial dependency creates a significant performance bottleneck when data resides in high-latency memory, as the processor effectively stalls at circle 2 and circle 3 while waiting for data fetching, unable to process the subsequent promising nodes (e.g., node 12) in the queue.

The performance of the four key operations varies depending on from which memory tier they are accessed.

This traditional approach uses is a single access per query. That is for a given query, a node/vector in the database will either not be used or used at most once to calculate the distance with query vector. Nodes may be used multiple times across different queries. To provide high throughput, multiple vector searches are executed in parallel with the total time is determined by the candidate's set size. A larger candidate set improves precision but also increases query time (latency).

An approach to improving traditional vectorDB queries may be to use traditional memory tiering techniques. However, these techniques are reactive and place the data based on the data hotness profile (or access profile) collected for a fixed time interval. Based on the profile, hot data is placed in the fast tier and cold data in cold tier. However, such as approach does not work well with vector databases due to a lack of algorithm awareness (they are oblivious to internal data structures), promotions are done on a best-effort basis with the assumption that a promoted page will be accessed many times after the promotion, and traditional tiering solutions operate on multi-second intervals, but vector search involves random and single-access patterns across large portions of the dataset. This causes all accessed nodes to appear equally “hot” and everything else as cold, leading to inefficient tiering decisions and thrashing.

Examples detailed herein describe improvements to traditional vectorDB querying. Specifically, opportunistic memory tiering leverages internal data structures of vector search algorithms to generate precise prefetch hints. In particular, nodes are prefetched while dot products are performed on in memory nodes. In some examples, a plurality of cache lines (e.g., 64) is prefetched as opposed to a default one cache line.

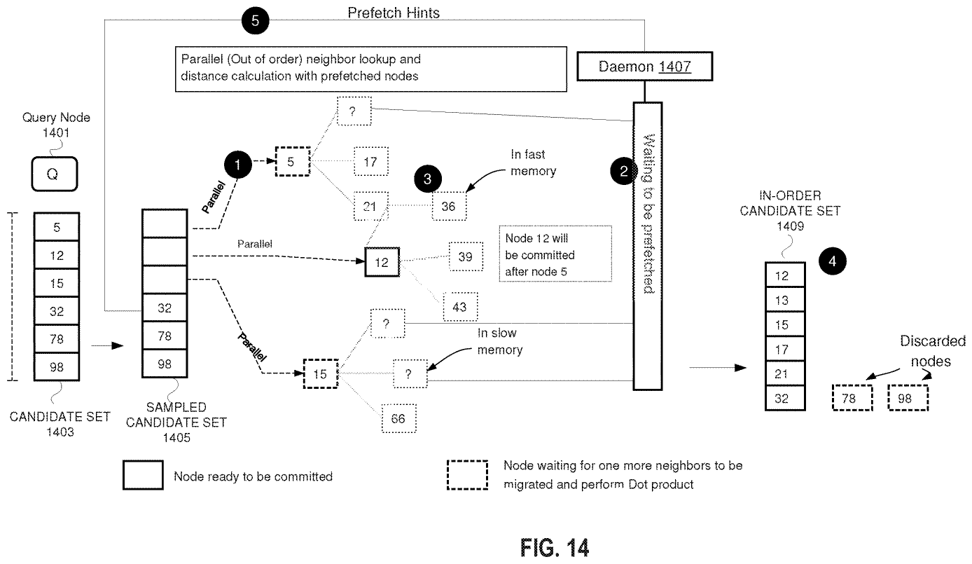

FIG. 14 is a diagram illustrating examples of opportunistic memory tiering and out-of-order execution flow for vector database lookup. In some examples, the vector DB search module 743 controls the depicted acts. The memory access latency is decoupled from the computational throughput by using prefetching as dot products are computed. This may mean that nodes are prefetched out-of-order with respect to the dot product distance calculations.

The process initiates with a query node 1401 entering the system. Similar to the traditional approach, the vectorDB search module 743 maintains a candidate set 1403, which acts as the primary frontier of the graph traversal, ordered by proximity to the query node 1401. However, rather than strictly processing only the single top element, the vectorDB search module 743 employs a lookahead mechanism that inspects multiple entries within the priority queue simultaneously.

From the candidate set 1403, the vectorDB search module 743 derives a sampled candidate set 1405. This sampling operation involves selecting a plurality of nodes that are likely to be visited in the relative near future, extending beyond the immediate head of the queue (e.g., selecting node 12 and node 15 in addition to the top node 5). This lookahead capability allows the system to identify memory requirements speculatively. The sampled candidate set 1405 is analyzed by a daemon 1407, which may be implemented as a dedicated background thread, a hardware logic block within the accelerator 703 or CPU 705, a specialized controller on a memory bus, etc. The daemon 1407 performs a residence check for the neighbors of the sampled nodes to determine whether their vector embeddings currently reside in the volatile “fast” memory 711 or the non-volatile “slow” memory 773.

Based on this residence analysis, the Daemon 1407 generates prefetch hints for any neighbor nodes identified as residing in the slow tier. For instance, in the scenario depicted, the daemon 1407 identifies that neighbors 36, 39, 43, and 66 are located in slow memory (e.g., CXL-attached DRAM or SSD). Consequently, the Daemon 1407 issues prefetch requests to the memory controller or the ML model memory manager 741 to initiate the migration of these specific data blocks into the fast tier. This proactive retrieval occurs in parallel with the ongoing search computations, effectively hiding the migration latency behind the execution of currently available tasks. By the time the graph traversal algorithm officially reaches these nodes in its logical sequence, the data is likely to have already arrived in the volatile “fast” memory 711, thereby preventing processor stalls.

The vectorDB search module 743 executes parallel, out-of-order neighbor lookups and distance calculations for those nodes that are already present in the fast tier. As illustrated, while the system waits for the migration of node 36 (a neighbor of node 5), it does not halt execution. Instead, it proceeds to compute the dot products for neighbors 17 and 21 (neighbors of node 5) and potentially neighbors of node 12 (e.g., node 15), provided they are accessible in the high-bandwidth memory. This out-of-order execution exploits the memory-level parallelism inherent in the hardware, keeping the arithmetic logic units (ALUs) of the accelerator 703 or CPU(s) 705 busy even if the logically prior data (node 36) is temporarily unavailable.

To preserve the algorithmic correctness of the graph traversal (e.g., ensuring the greedy search invariants of HNSW are maintained), the vectorDB search module 743 utilizes an in-order candidate set 1409. Although the distance calculations and neighbor expansions occur out-of-order based on data availability, the results are committed to the in-order candidate set 1409 strictly in accordance with the algorithm's priority logic. For example, even if the processing for node 12 finishes before node 5 is fully resolved (due to node 5 waiting for the slow neighbor 36), the updates resulting from node 12 are held in a temporary state. Node 12 is “committed”—meaning its neighbors are officially added to the active frontier and worst candidates are discarded—only after node 5 has been fully processed and committed. This ensures that the discard logic correctly identifies the globally worst nodes (e.g., nodes 78 and 98) based on a complete and consistent view of the search frontier, preventing the accidental pruning of valid paths due to out-of-order partial results. Thus, the in-order candidate set 1409 synchronizes the high-throughput, asynchronous hardware execution with the sequential logical requirements of the search algorithm.

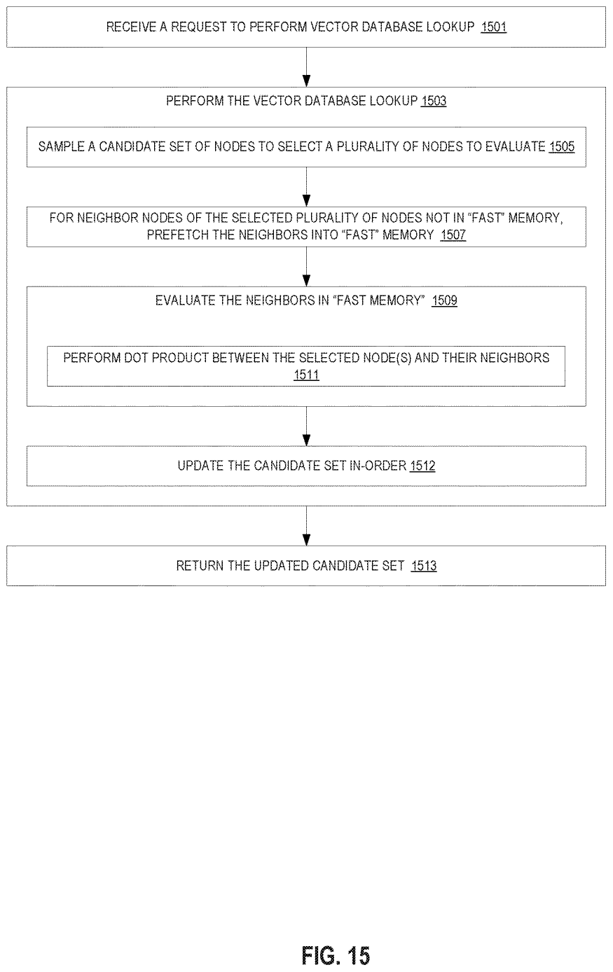

FIG. 15 is a flow diagram illustrating examples of a method for performing a vector database lookup utilizing opportunistic memory tiering and out-of-order execution. The method leverages the hierarchical memory architecture described in FIG. 7 to optimize the trade-off between lookup latency and memory capacity costs. The operations depicted are performed by the vectorDB search module 743, operating in conjunction with the compute hardware 701 and/or the ML model memory manager 741.

At 1501, the vectorDB search module 743 receives a request to perform a vector database lookup. The vectorDB search module 743 accepts a search query payload from a client application or an upstream machine learning service (e.g., a Retrieval-Augmented Generation pipeline). This payload typically comprises a high-dimensional query vector (e.g., a 1024-dimension float32 embedding) representing the semantic content of an input, along with search configuration parameters. These parameters may include the number of nearest neighbors to retrieve (k), the size of the dynamic candidate list to maintain during traversal (often denoted as ‘ef_search’), and potentially a maximum time budget or latency constraint. Upon receipt, the vectorDB search module 743 parses the request and allocates the necessary internal data structures in the volatile “fast” memory 711, including the initialization of the candidate set 1403 and the in-order candidate set 1409.

At 1503, the vectorDB search module 743 begins to perform the vector database lookup. The search module initiates the graph traversal algorithm, such as the HNSW algorithm, by identifying an entry point node in the graph structure stored within the vector database 735. In an HNSW implementation, this may involve traversing upper layers of the graph stored in the fast memory 711 to locate a greedy entry point in the base layer (layer 0). Once the entry point is established, the node is inserted into the candidate set 1403, and the iterative search loop commences. Unlike conventional sequential processing, the search module is configured to manage execution based on data availability rather than strict topological order.

At 1505, the system samples a candidate set of nodes to select a plurality of nodes to evaluate. Instead of retrieving only the single highest-priority element from the candidate set 1403, the vectorDB search module 743 employs a lookahead sampling mechanism. The vectorDB search module 743 inspects the top N elements of the priority queue (where N may be a configurable lookahead window size) to construct a sampled candidate set 1405. This sampling provides a broader view of the search frontier, identifying not just the immediate next node to process, but also subsequent nodes that are highly likely to be required in the near future.

At 1507, for neighbor nodes of the selected plurality of nodes that are not in “fast” memory, the system prefetches the neighbors into “fast” memory. The vectorDB search module 743 (which may include or utilize daemon 1407), performs a residency check for the neighbor lists associated with each node in the sampled candidate set 1405. This check involves querying a page table, a hash map, or a hardware-managed directory to determine whether the vector data for a given neighbor resides in the volatile “fast” memory 711 or the non-volatile “slow” memory 773. When a neighbor node is identified as residing in the slow tier (e.g., CXL-attached memory or SSD), the vectorDB search module 743 generates a precise prefetch hint.

In some examples, the vectorDB search module 743 applies a hybrid tiering strategy based on the estimated “time slack” or the time remaining before the algorithm logically requires the node. If the node is deep in the sampled candidate set 1405 (implying a larger time slack), the vectorDB search module 743 issues a page migration request to move the entire 4 KB page containing the vector from the slow memory 773 to the fast memory 711. This migration may be offloaded to an accelerator or DMA engine to maximize bandwidth efficiency. Conversely, if the node is near the top of the candidate set (implying minimal time slack), the vectorDB search module 743 may initiate a cache-line prefetch, promoting only the specific cache lines (e.g., 64 bytes) containing the vector data directly into the CPU cache or the fast memory 711. This granular approach minimizes the latency penalty for urgent data while optimizing bandwidth for bulk data.

At 1509, the vectorDB search module 743 evaluates the neighbors in “fast memory”. While the prefetch requests for the slow-tier nodes are being serviced, the vectorDB search module 743 proceeds to process those neighbor nodes that were identified as already resident in the volatile “fast” memory 711. This constitutes the out-of-order execution phase. The vectorDB search module 743 iterates through the available resident nodes from the sampled candidate set 1405, decoupling the execution order from the strict priority order of the candidate set. By processing the available data immediately, the compute hardware 701 remains utilized, preventing pipeline stalls that would otherwise occur while waiting for data fetching from the slow tier.

At 1511, the vectorDB search module 743 performs a dot product between the selected node(s) and their neighbors. Utilizing the accelerator 703 (e.g., SIMD units, AMX tiles, or GPU cores) or CPUs 705, the vectorDB search module 743 computes the similarity metric—typically a dot product as a part of a cosine similarity or distance calculation—between the query vector and the vector embeddings of the neighbor nodes. Because this operation is performed on data confirmed to be in the high-bandwidth fast memory 711 (or pre-fetched into the processor cache), the computation achieves maximum throughput. The results of these calculations are temporary “future” results that must be reconciled with the graph traversal logic.

At 1512, the vectorDB search module 743 updates the candidate set in-order, and the updated candidate set is returned at 1513. To maintain the algorithmic integrity of the graph traversal (e.g., ensuring that the greedy search does not deviate from valid paths), the vectorDB search module 743 commits the results of the out-of-order dot products to the in-order candidate set 1409. The vectorDB search module 743 may utilize a reorder buffer logic wherein a node's neighbors are added to the candidate set, and the node is marked as “visited,” only when all of its logical predecessors in the priority queue have been processed. If a high-priority node was waiting for data migration (from operation 1507), the system holds the results of lower-priority nodes in a temporary buffer. Once the migration completes and the high-priority node is processed, the system commits the accumulated results in the correct sequence. This step also involves a “delayed demotion” policy. Rather than immediately evicting the promoted vectors after the calculation, the vectorDB search module 743 may retain them in the fast memory 711 for a predetermined decay period or until memory pressure necessitates eviction. This cooperative retention allows other concurrent threads or subsequent queries accessing the same region of the graph to reuse the data, thereby reducing thrashing and overall memory traffic between the tiers.

While the description focuses on using HNSW graphs, the opportunistic tiering and out-of-order execution mechanisms are applicable to Inverted File (IVF) index structures or other clustering-based approximate nearest neighbor algorithms. In an IVF implementation, the “nodes” described in the candidate set 1403 correspond to cluster centroids or inverted lists (posting lists) rather than individual graph vertices. When the vectorDB search module 743 identifies a set of nearest centroids (the top-level coarse search), these centroids form the initial candidate set. The system then employs the lookahead mechanism to identify which inverted lists (stored in the non-volatile “slow” memory 773) correspond to these centroids. The daemon 1407 initiates the prefetching of these potentially large blocks of vector data into the volatile “fast” memory 711. Concurrently, the search module evaluates the distance metrics for vectors within inverted lists that are already resident in the fast memory, employing the same out-of-order execution and in-order commitment logic described with reference to FIG. 14.

The size of the lookahead window, defined by the depth to which the sampled candidate set 1405 is populated—may be dynamically adjusted based on real-time system telemetry rather than a fixed configuration. The vectorDB search module 743 may continuously monitor the saturation level of the memory bandwidth between the volatile “fast” memory 711 and the non-volatile “slow” memory 773. During periods of low memory bus utilization, the system may switch to an “aggressive” mode, increasing the size of the sampled candidate set 1405 to prefetch nodes much deeper in the priority queue, effectively trading excess bandwidth for a higher probability of cache hits. Conversely, if the memory controller detects high contention or latency spikes, the system may retract the lookahead window to fetch only the most critical nodes, thereby preventing thrashing and ensuring that the prefetch traffic does not interfere with the demand-fetch latency of the currently processing nodes. This dynamic adjustment allows the system to balance the benefits of latency hiding with the physical constraints of the hardware interface.

In some examples, the prefetching mechanism may utilize speculative query clustering. When the vectorDB search module 743 receives a batch of queries (e.g., in a high-throughput server environment), it analyzes the spatial locality of the entry points and the initial traversal paths of the query vectors. If a subset of queries is determined to be clustered in a specific region of the high-dimensional space, the system aggregates the sampled candidate sets 1405 for all queries in the cluster. The daemon 1407 then issues bulk prefetch requests for the union of the neighbor nodes identified across these sets. This approach leverages the likelihood that spatially similar queries will traverse common sub-graphs or access common hub nodes. By fetching these shared nodes once and pinning them in the volatile “fast” memory 711 for the duration of the batch processing, the system maximizes the cooperative reuse of the data and minimizes the redundant issuing of migration commands for the same memory pages. Implementation-wise, this may be achieved using asynchronous I/O interfaces such as ‘io_uring’ in Linux, allowing the prefetcher threads 811/817 to submit chains of dependent memory operations (read from slow, write to fast) to the kernel without blocking user-space execution threads.

### Example Architectures

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

### Example Systems

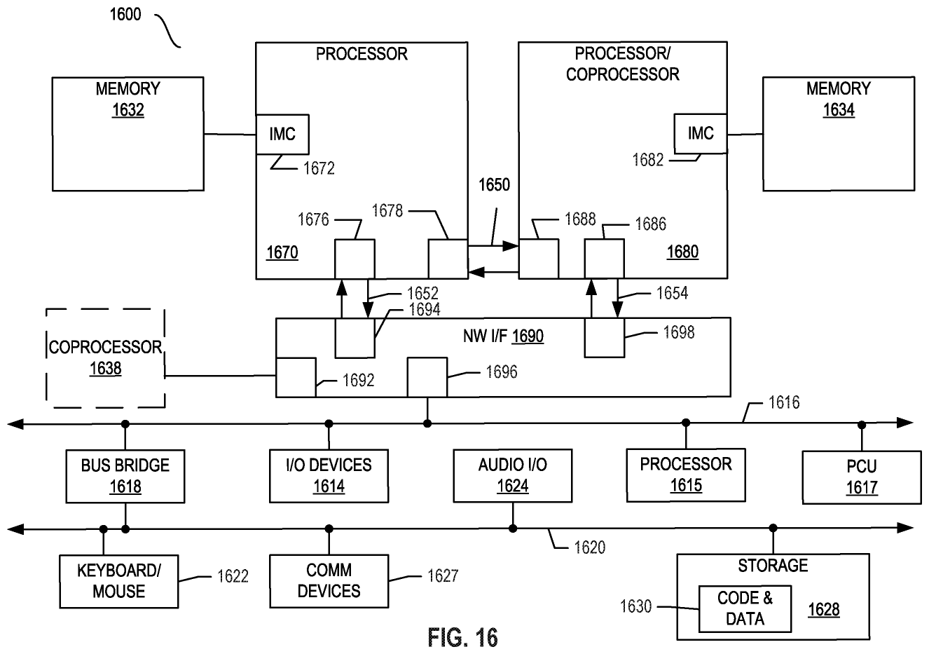

FIG. 16 illustrates an example computing system. Multiprocessor system 1600 is an interfaced system and includes a plurality of processors or cores including a first processor 1670 and a second processor 1680 coupled via an interface 1650 such as a point-to-point (P-P) interconnect, a fabric, and/or bus. In some examples, the first processor 1670 and the second processor 1680 are homogeneous. In some examples, first processor 1670 and the second processor 1680 are heterogenous. Though the example multiprocessor system 1600 is shown to have two processors, the system may have three or more processors, or may be a single processor system. In some examples, the computing system is a system on a chip (SoC).

Processors 1670 and 1680 are shown including integrated memory controller (IMC) circuitry 1672 and 1682, respectively. Processor 1670 also includes interface circuits 1676 and 1678; similarly, second processor 1680 includes interface circuits 1686 and 1688. Processors 1670, 1680 may exchange information via the interface 1650 using interface circuits 1678, 1688. IMCs 1672 and 1682 couple the processors 1670, 1680 to respective memories, namely a memory 1632 and a memory 1634, which may be portions of main memory locally attached to the respective processors.

Processors 1670, 1680 may each exchange information with a network interface (NW I/F) 1690 via individual interfaces 1652, 1654 using interface circuits 1676, 1694, 1686, 1698. The network interface 1690 (e.g., one or more of an interconnect, bus, and/or fabric, and in some examples is a chipset) may optionally exchange information with a co-processor 1638 via an interface circuit 1692. In some examples, the co-processor 1638 is a special-purpose processor, such as, for example, a high-throughput processor, a network or communication processor, a compression engine, a graphics processor, a general purpose graphics processing unit (GPGPU), a neural-network processing unit (NPU), an embedded processor, a security processor, a cryptographic accelerator, a matrix accelerator, an in-memory analytics accelerator, a data streaming accelerator, data graph operations, or the like.

A shared cache (not shown) may be included in either processor 1670, 1680 or outside of both processors, yet connected with the processors via an interface such as P-P interconnect, such that either or both processors' local cache information may be stored in the shared cache if a processor is placed into a low power mode.

Network interface 1690 may be coupled to a first interface 1616 via interface circuit 1696. In some examples, first interface 1616 may be an interface such as a Peripheral Component Interconnect (PCI) interconnect, a PCI Express interconnect or another I/O interconnect. In some examples, first interface 1616 is coupled to a power control unit (PCU) 1617, which may include circuitry, software, and/or firmware to perform power management operations with regard to the processors 1670, 1680 and/or co-processor 1638. PCU 1617 provides control information to a voltage regulator (not shown) to cause the voltage regulator to generate the appropriate regulated voltage. PCU 1617 also provides control information to control the operating voltage generated. In various examples, PCU 1617 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 1617 is illustrated as being present as logic separate from the processor 1670 and/or processor 1680. In other cases, PCU 1617 may execute on a given one or more of cores (not shown) of processor 1670 or 1680. In some cases, PCU 1617 may be implemented as a microcontroller (dedicated or general-purpose) or other control logic configured to execute its own dedicated power management code, sometimes referred to as P-code. In yet other examples, power management operations to be performed by PCU 1617 may be implemented externally to a processor, such as by way of a separate power management integrated circuit (PMIC) or another component external to the processor. In yet other examples, power management operations to be performed by PCU 1617 may be implemented within BIOS or other system software.

Various I/O devices 1614 may be coupled to first interface 1616, along with a bus bridge 1618 which couples first interface 1616 to a second interface 1620. In some examples, one or more additional processor(s) 1615, such as co-processors, high throughput many integrated core (MIC) processors, GPGPUs, accelerators (such as graphics accelerators or digital signal processing (DSP) units), field programmable gate arrays (FPGAs), or any other processor, are coupled to first interface 1616. In some examples, second interface 1620 may be a low pin count (LPC) interface. Various devices may be coupled to second interface 1620 including, for example, a keyboard and/or mouse 1622, communication devices 1627 and storage circuitry 1628. Storage circuitry 1628 may be one or more non-transitory machine-readable storage media as described below, such as a disk drive or other mass storage device which may include instructions/code and data 1630 and may implement the storage in some examples. Further, an audio I/O 1624 may be coupled to second interface 1620. Note that other architectures than the point-to-point architecture described above are possible. For example, instead of the point-to-point architecture, a system such as multiprocessor system 1600 may implement a multi-drop interface or other such architecture.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a co-processor including one or more special purpose cores intended primarily for graphics and/or scientific (throughput) computing. Such different processors lead to different computer system architectures, which may include: 1) the co-processor on a separate chip from the CPU; 2) the co-processor on a separate die in the same package as a CPU; 3) the co-processor on the same die as a CPU (in which case, such a co-processor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described co-processor, and additional functionality. Example core architectures are described next, followed by descriptions of example processors and computer architectures.

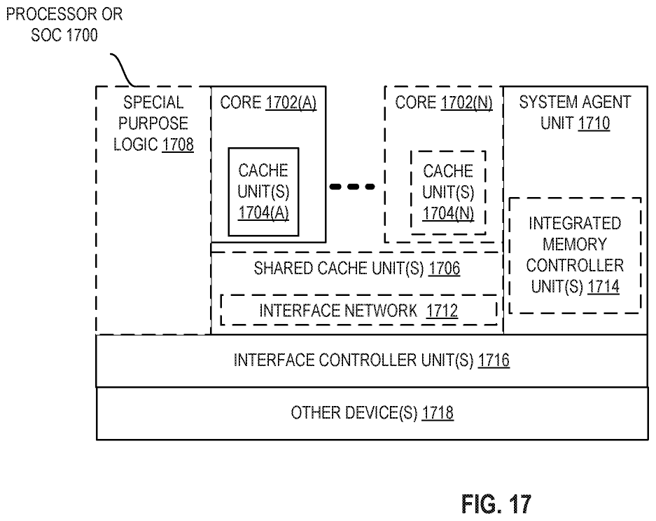

FIG. 17 illustrates a block diagram of an example processor and/or SoC 1700 that may have one or more cores and an integrated memory controller. The solid lined boxes illustrate a processor and/or SoC 1700 with a single core 1702(A), system agent unit circuitry 1710, and a set of one or more interface controller unit(s) circuitry 1716, while the optional addition of the dashed lined boxes illustrates an alternative processor and/or SoC 1700 with multiple cores 1702(A)-(N), a set of one or more integrated memory controller unit(s) circuitry 1714 in the system agent unit circuitry 1710, and special purpose logic 1708, as well as a set of one or more interface controller unit(s) circuitry 1716. Note that the processor and/or SoC 1700 may be one of the processors 1670 or 1680, or co-processor 1638 or 1615 of FIG. 16.

Thus, different implementations of the processor and/or SoC 1700 may include: 1) a CPU with the special purpose logic 1708 being a high-throughput processor, a network or communication processor, a compression engine, a graphics processor, a general purpose graphics processing unit (GPGPU), a neural-network processing unit (NPU), an embedded processor, a security processor, a matrix accelerator, an in-memory analytics accelerator, a compression accelerator, a data streaming accelerator, data graph operations, or the like (which may include one or more cores, not shown), and the cores 1702(A)-(N) being one or more general purpose cores (e.g., general purpose in-order cores, general purpose out-of-order cores, or a combination of the two); 2) a co-processor with the cores 1702(A)-(N) being a large number of special purpose cores intended primarily for graphics and/or scientific (throughput); and 3) a co-processor with the cores 1702(A)-(N) being a large number of general purpose in-order cores. Thus, the processor and/or SoC 1700 may be a general-purpose processor, co-processor or special-purpose processor, such as, for example, a network or communication processor, compression engine, graphics processor, GPGPU (general purpose graphics processing unit), a high throughput many integrated core (MIC) co-processor (including 30 or more cores), embedded processor, or the like. The processor may be implemented on one or more chips. The processor and/or SoC 1700 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1704(A)-(N) within the cores 1702(A)-(N), a set of one or more shared cache unit(s) circuitry 1706, and external memory (not shown) coupled to the set of integrated memory controller unit(s) circuitry 1714. The set of one or more shared cache unit(s) circuitry 1706 may include one or more mid-level caches, such as level 2 (L2), level 3 (L3), level 4 (L4), or other levels of cache, such as a last level cache (LLC), and/or combinations thereof. While in some examples interface network circuitry 1712 (e.g., a ring interconnect) interfaces the special purpose logic 1708 (e.g., integrated graphics logic), the set of shared cache unit(s) circuitry 1706, and the system agent unit circuitry 1710, alternative examples use any number of well-known techniques for interfacing such units. In some examples, coherency is maintained between one or more of the shared cache unit(s) circuitry 1706 and cores 1702(A)-(N). In some examples, interface controller unit(s) circuitry 1716 couple the cores 1702(A)-(N) to one or more other devices 1718 such as one or more I/O devices, storage, one or more communication devices (e.g., wireless networking, wired networking, etc.), etc.

In some examples, one or more of the cores 1702(A)-(N) are capable of multi-threading. The system agent unit circuitry 1710 includes those components coordinating and operating cores 1702(A)-(N). The system agent unit circuitry 1710 may include, for example, power control unit (PCU) circuitry and/or display unit circuitry (not shown). The PCU may be or may include logic and components needed for regulating the power state of the cores 1702(A)-(N) and/or the special purpose logic 1708 (e.g., integrated graphics logic). The display unit circuitry is for driving one or more externally connected displays.

The cores 1702(A)-(N) may be homogenous in terms of instruction set architecture (ISA). Alternatively, the cores 1702(A)-(N) may be heterogeneous in terms of ISA; that is, a subset of the cores 1702(A)-(N) may be capable of executing an ISA, while other cores may be capable of executing only a subset of that ISA or another ISA.

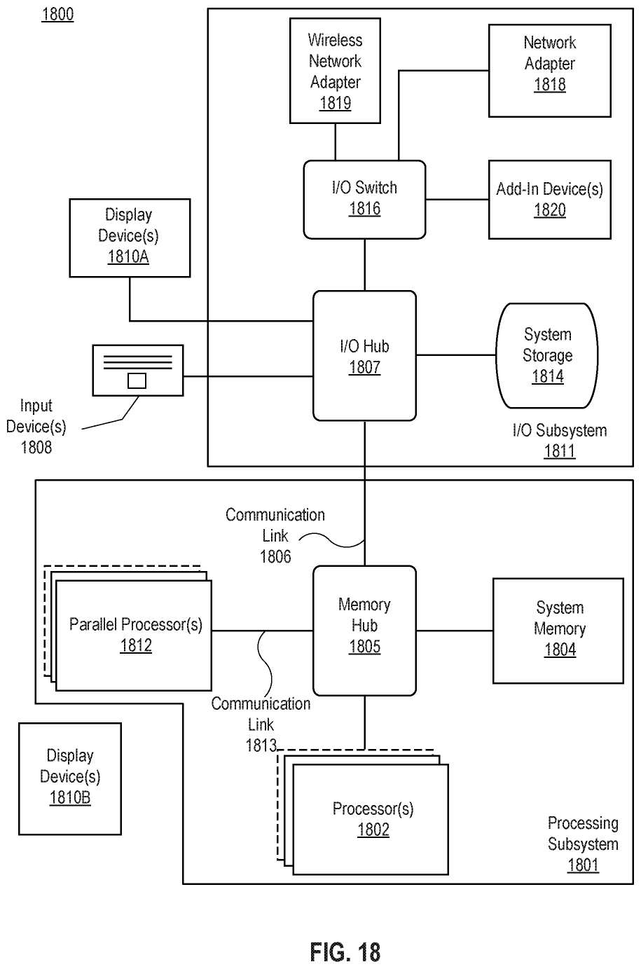

FIG. 18 is a block diagram illustrating a computing system 1800 configured to implement one or more aspects of the examples described herein. The computing system 1800 includes a processing subsystem 1801 having one or more processor(s) 1802 and a system memory 1804 communicating via an interconnection path that may include a memory hub 1805. The memory hub 1805 may be a separate component within a chipset component or may be integrated within the one or more processor(s) 1802. The memory hub 1805 couples with an I/O subsystem 1811 via a communication link 1806. The I/O subsystem 1811 includes an I/O hub 1807 that can enable the computing system 1800 to receive input from one or more input device(s) 1808. Additionally, the I/O hub 1807 can enable a display controller, which may be included in the one or more processor(s) 1802, to provide outputs to one or more display device(s) 1810A. In some examples the one or more display device(s) 1810A coupled with the I/O hub 1807 can include a local, internal, or embedded display device.

The processing subsystem 1801, for example, includes one or more parallel processor(s) 1812 coupled to memory hub 1805 via a bus or communication link 1813. The communication link 1813 may be one of any number of standards-based communication link technologies or protocols, such as, but not limited to PCI Express, or may be a vendor specific communications interface or communications fabric. The one or more parallel processor(s) 1812 may form a computationally focused parallel or vector processing system that can include a large number of processing cores and/or processing clusters, such as a many integrated core (MIC) processor. For example, the one or more parallel processor(s) 1812 form a graphics processing subsystem that can output pixels to one of the one or more display device(s) 1810A coupled via the I/O hub 1807. The one or more parallel processor(s) 1812 can also include a display controller and display interface (not shown) to enable a direct connection to one or more display device(s) 1810B.

Within the I/O subsystem 1811, a system storage unit 1814 can connect to the I/O hub 1807 to provide a storage mechanism for the computing system 1800. An I/O switch 1816 can be used to provide an interface mechanism to enable connections between the I/O hub 1807 and other components, such as a network adapter 1818 and/or wireless network adapter 1819 that may be integrated into the platform, and various other devices that can be added via one or more add-in device(s) 1820. The add-in device(s) 1820 may also include, for example, one or more external graphics processor devices, graphics cards, and/or compute accelerators. The network adapter 1818 can be an Ethernet adapter or another wired network adapter. The wireless network adapter 1819 can include one or more of a Wi-Fi, Bluetooth, near field communication (NFC), or other network device that includes one or more wireless radios.

The computing system 1800 can include other components not explicitly shown, including USB or other port connections, optical storage drives, video capture devices, and the like, which may also be connected to the I/O hub 1807. Communication paths interconnecting the various components in FIG. 18 may be implemented using any suitable protocols, such as PCI (Peripheral Component Interconnect) based protocols (e.g., PCI-Express), or any other bus or point-to-point communication interfaces and/or protocol(s), such as the NVLink high-speed interconnect, Compute Express Link™ (CXL™) (e.g., CXL.mem), Infinity Fabric (IF), Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Intel QuickPath Interconnect (QPI), Intel Ultra Path Interconnect (UPI), Intel On-Chip System Fabric (IOSF), Omnipath, HyperTransport, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof, or wired or wireless interconnect protocols known in the art. In some examples, data can be copied or stored to virtualized storage nodes using a protocol such as non-volatile memory express (NVMe) over Fabrics (NVMe-oF) or NVMe.

The one or more parallel processor(s) 1812 may incorporate circuitry optimized for graphics and video processing, including, for example, video output circuitry, and constitutes a graphics processing unit (GPU). Alternatively or additionally, the one or more parallel processor(s) 1812 can incorporate circuitry optimized for general purpose processing, while preserving the underlying computational architecture, described in greater detail herein. Components of the computing system 1800 may be integrated with one or more other system elements on a single integrated circuit. For example, the one or more parallel processor(s) 1812, memory hub 1805, processor(s) 1802, and I/O hub 1807 can be integrated into a system on chip (SoC) integrated circuit. Alternatively, the components of the computing system 1800 can be integrated into a single package to form a system in package (SIP) configuration. In some examples at least a portion of the components of the computing system 1800 can be integrated into a multi-chip module (MCM), which can be interconnected with other multi-chip modules into a modular computing system.

It will be appreciated that the computing system 1800 shown herein is illustrative and that variations and modifications are possible. The connection topology, including the number and arrangement of bridges, the number of processor(s) 1802, and the number of parallel processor(s) 1812, may be modified as desired. For instance, system memory 1804 can be connected to the processor(s) 1802 directly rather than through a bridge, while other devices communicate with system memory 1804 via the memory hub 1805 and the processor(s) 1802. In other alternative topologies, the parallel processor(s) 1812 are connected to the I/O hub 1807 or directly to one of the one or more processor(s) 1802, rather than to the memory hub 1805. In other examples, the I/O hub 1807 and memory hub 1805 may be integrated into a single chip. It is also possible that two or more sets of processor(s) 1802 are attached via multiple sockets, which can couple with two or more instances of the parallel processor(s) 1812.

Some of the particular components shown herein are optional and may not be included in all implementations of the computing system 1800. For example, any number of add-in cards or peripherals may be supported, or some components may be eliminated. Furthermore, some architectures may use different terminology for components similar to those illustrated in FIG. 18. For example, the memory hub 1805 may be referred to as a Northbridge in some architectures, while the I/O hub 1807 may be referred to as a Southbridge.

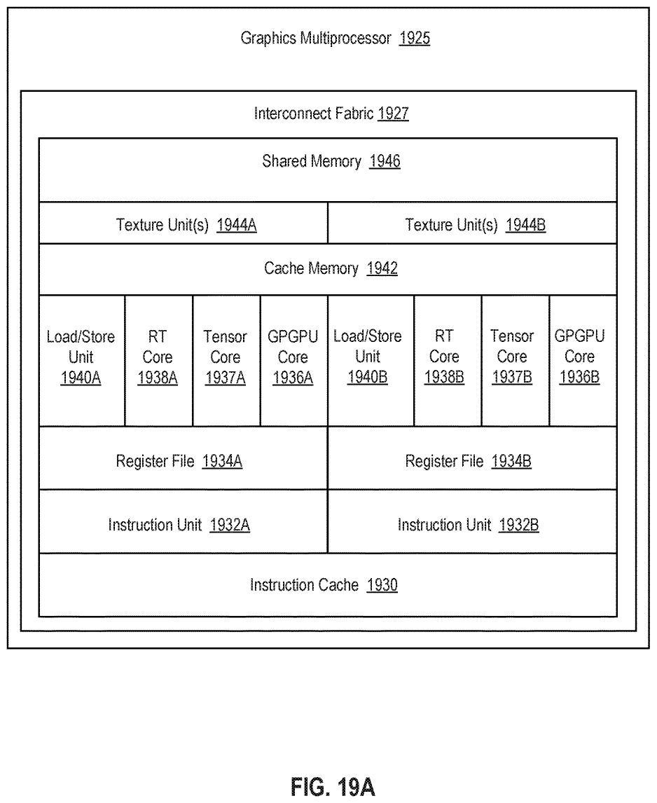

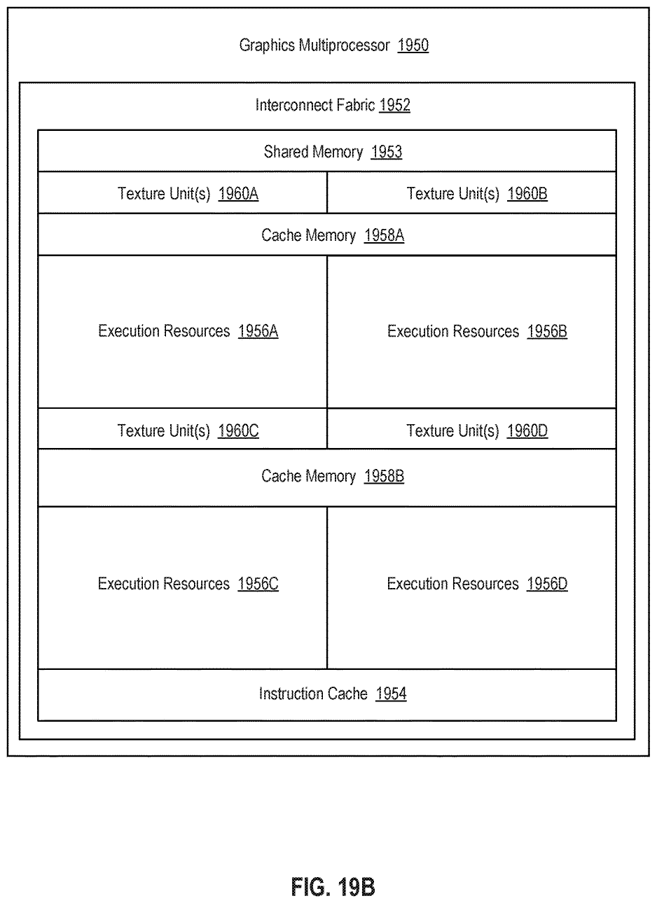

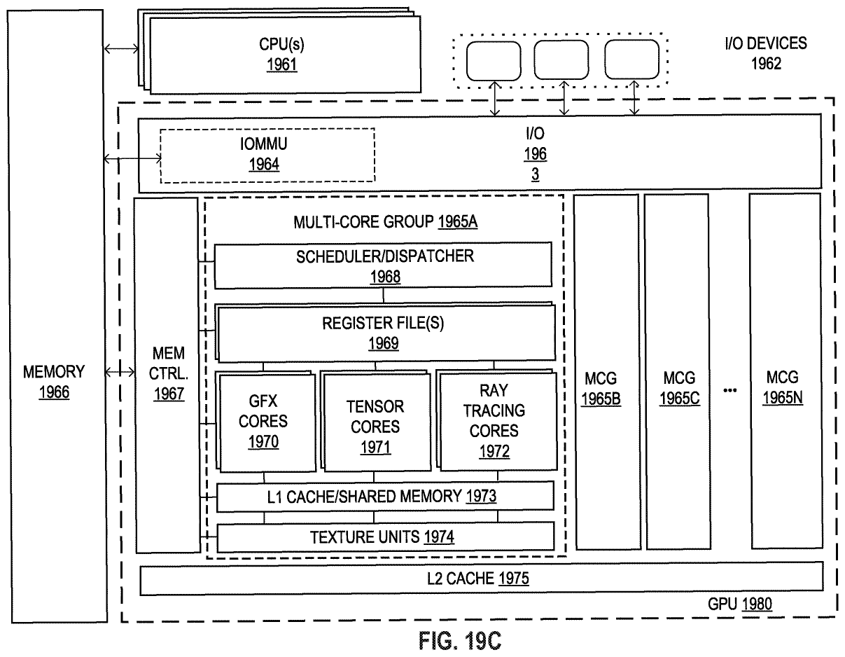

FIGS. 19A-19C illustrate graphics multiprocessors, according to examples. FIG. 19A-19B illustrate graphics multiprocessors 1925, 1950, which are related to the graphics multiprocessor. Therefore, the disclosure of any features in combination with the graphics multiprocessor herein also discloses a corresponding combination with the graphics multiprocessors 1925, 1950, but is not limited to such. FIG. 19C illustrates a graphics processing unit (GPU) 1980 which includes dedicated sets of graphics processing resources arranged into multi-core groups 1965A-1965N, which correspond to the graphics multiprocessors 1925, 1950. The illustrated graphics multiprocessors 1925, 1950 and the multi-core groups 1965A-1965N can be streaming multiprocessors (SM) capable of simultaneous execution of a large number of execution threads.

The graphics multiprocessor 1925 of FIG. 19A includes multiple additional instances of execution resource units relative to the graphics multiprocessor. For example, the graphics multiprocessor 1925 can include multiple instances of the instruction unit 1932A-1932B, register file 1934A-1934B, and texture unit(s) 1944A-1944B. The graphics multiprocessor 1925 also includes multiple sets of graphics or compute execution units (e.g., GPGPU core 1936A-1936B, tensor core 1937A-1937B, ray-tracing core 1938A-1938B) and multiple sets of load/store units 1940A-1940B. The execution resource units have a common instruction cache 1930, texture and/or data cache memory 1942, and shared memory 1946.

The various components can communicate via an interconnect fabric 1927. The interconnect fabric 1927 may include one or more crossbar switches to enable communication between the various components of the graphics multiprocessor 1925. The interconnect fabric 1927 may be a separate, high-speed network fabric layer upon which each component of the graphics multiprocessor 1925 is stacked. The components of the graphics multiprocessor 1925 communicate with remote components via the interconnect fabric 1927. For example, the cores 1936A-1936B, 1937A-1937B, and 1938A-1938B can each communicate with shared memory 1946 via the interconnect fabric 1927. The interconnect fabric 1927 can arbitrate communication within the graphics multiprocessor 1925 to ensure a fair bandwidth allocation between components.

The graphics multiprocessor 1950 of FIG. 19B includes multiple sets of execution resources 1956A-1956D, where each set of execution resource includes multiple instruction units, register files, GPGPU cores, and load store units. The execution resources 1956A-1956D can work in concert with texture unit(s) 1960A-1960D for texture operations, while sharing an instruction cache 1954, and shared memory 1953. For example, the execution resources 1956A-1956D can share an instruction cache 1954 and shared memory 1953, as well as multiple instances of a texture and/or data cache memory 1958A-1958B. The various components can communicate via an interconnect fabric 1952 similar to the interconnect fabric 1927 of FIG. 19A.

Persons skilled in the art will understand that the architecture described in FIGS. 1 and 19A-19B are descriptive and not limiting as to the scope of the present examples. Thus, the techniques described herein may be implemented on any properly configured processing unit, including, without limitation, one or more mobile application processors, one or more desktop or server central processing units (CPUs) including multi-core CPUs, one or more parallel processing units, such as the parallel processing unit, as well as one or more graphics processors or special purpose processing units, without departure from the scope of the examples described herein.

The parallel processor or GPGPU as described herein may be communicatively coupled to host/processor cores to accelerate graphics operations, machine-learning operations, pattern analysis operations, and various general-purpose GPU (GPGPU) functions. The GPU may be communicatively coupled to the host processor/cores over a bus or other interconnect (e.g., a high-speed interconnect such as PCIe, NVLink, or other known protocols, standardized protocols, or proprietary protocols). In other examples, the GPU may be integrated on the same package or chip as the cores and communicatively coupled to the cores over an internal processor bus/interconnect (i.e., internal to the package or chip). Regardless of the manner in which the GPU is connected, the processor cores may allocate work to the GPU in the form of sequences of commands/instructions contained in a work descriptor. The GPU then uses dedicated circuitry/logic for efficiently processing these commands/instructions.

FIG. 19C illustrates a graphics processing unit (GPU) 1980 which includes dedicated sets of graphics processing resources arranged into multi-core groups 1965A-1965N. While the details of only a single multi-core group 1965A are provided, it will be appreciated that the other multi-core groups 1965B-1965N may be equipped with the same or similar sets of graphics processing resources. Details described with respect to the multi-core groups 1965A-1965N may also apply to any graphics multiprocessor, 1925, 1950 described herein.

As illustrated, a multi-core group 1965A may include a set of graphics cores 1970, a set of tensor cores 1971, and a set of ray tracing cores 1972. A scheduler/dispatcher 1968 schedules and dispatches the graphics threads for execution on the various cores 1970, 1971, 1972. A set of register files 1969 store operand values used by the cores 1970, 1971, 1972 when executing the graphics threads. These may include, for example, integer registers for storing integer values, floating point registers for storing floating point values, vector registers for storing packed data elements (integer and/or floating-point data elements) and tile registers for storing tensor/matrix values. The tile registers may be implemented as combined sets of vector registers.

One or more combined level 1 (L1) caches and shared memory units 1973 store graphics data such as texture data, vertex data, pixel data, ray data, bounding volume data, etc., locally within each multi-core group 1965A. One or more texture units 1974 can also be used to perform texturing operations, such as texture mapping and sampling. A Level 2 (L2) cache 1975 shared by all or a subset of the multi-core groups 1965A-1965N stores graphics data and/or instructions for multiple concurrent graphics threads. As illustrated, the L2 cache 1975 may be shared across a plurality of multi-core groups 1965A-1965N. One or more memory controllers 1967 couple the GPU 1980 to a memory 1966 which may be a system memory (e.g., DRAM) and/or a dedicated graphics memory (e.g., GDDR6 memory).

Input/output (I/O) circuitry 1963 couples the GPU 1980 to one or more I/O devices 1962 such as digital signal processors (DSPs), network controllers, or user input devices. An on-chip interconnect may be used to couple the I/O devices 1962 to the GPU 1980 and memory 1966. One or more I/O memory management units (IOMMUs) 1964 of the I/O circuitry 1963 couple the I/O devices 1962 directly to the system memory 1966. Optionally, the IOMMU 1964 manages multiple sets of page tables to map virtual addresses to physical addresses in system memory 1966. The I/O devices 1962, CPU(s) 1961, and GPU(s) 1980 may then share the same virtual address space.

In one implementation of the IOMMU 1964, the IOMMU 1964 supports virtualization. In this case, it may manage a first set of page tables to map guest/graphics virtual addresses to guest/graphics physical addresses and a second set of page tables to map the guest/graphics physical addresses to system/host physical addresses (e.g., within system memory 1966). The base addresses of each of the first and second sets of page tables may be stored in control registers and swapped out on a context switch (e.g., so that the new context is provided with access to the relevant set of page tables). While not illustrated in FIG. 19C, each of the cores 1970, 1971, 1972 and/or multi-core groups 1965A-1965N may include translation lookaside buffers (TLBs) to cache guest virtual to guest physical translations, guest physical to host physical translations, and guest virtual to host physical translations.

The CPU(s) 1961, GPUs 1980, and I/O devices 1962 may be integrated on a single semiconductor chip and/or chip package. The illustrated memory 1966 may be integrated on the same chip or may be coupled to the memory controllers 1967 via an off-chip interface. In one implementation, the memory 1966 comprises GDDR6 memory which shares the same virtual address space as other physical system-level memories, although the underlying principles described herein are not limited to this specific implementation.

The tensor cores 1971 may include a plurality of execution units specifically designed to perform matrix operations, which are the fundamental compute operation used to perform deep learning operations. For example, simultaneous matrix multiplication operations may be used for neural network training and inferencing. The tensor cores 1971 may perform matrix processing using a variety of operand precisions including single precision floating-point (e.g., 32 bits), half-precision floating point (e.g., 16 bits), integer words (16 bits), bytes (8 bits), and half-bytes (4 bits). For example, a neural network implementation extracts features of each rendered scene, potentially combining details from multiple frames, to construct a high-quality final image.

In deep learning implementations, parallel matrix multiplication work may be scheduled for execution on the tensor cores 1971. The training of neural networks, in particular, requires a significant number of matrix dot product operations. In order to process an inner-product formulation of an N×N×N matrix multiply, the tensor cores 1971 may include at least N dot-product processing elements. Before the matrix multiply begins, one entire matrix is loaded into tile registers and at least one column of a second matrix is loaded each cycle for N cycles. Each cycle, there are N dot products that are processed.

Matrix elements may be stored at different precisions depending on the particular implementation, including 16-bit words, 8-bit bytes (e.g., INT8) and 4-bit half-bytes (e.g., INT4). Different precision modes may be specified for the tensor cores 1971 to ensure that the most efficient precision is used for different workloads (e.g., such as inferencing workloads which can tolerate quantization to bytes and half-bytes). Supported formats additionally include 64-bit floating point (FP64) and non-IEEE floating point formats such as the bfloat16 format (e.g., Brain floating point), a 16-bit floating point format with one sign bit, eight exponent bits, and eight significand bits, of which seven are explicitly stored. One example includes support for a reduced precision tensor-float (TF32) mode, which performs computations using the range of FP32 (8-bits) and the precision of FP16 (10-bits). Reduced precision TF32 operations can be performed on FP32 inputs and produce FP32 outputs at higher performance relative to FP32 and increased precision relative to FP16. In some examples, one or more 8-bit floating point formats (FP8) are supported.

In some examples the tensor cores 1971 support a sparse mode of operation for matrices in which the vast majority of values are zero. The tensor cores 1971 include support for sparse input matrices that are encoded in a sparse matrix representation (e.g., coordinate list encoding (COO), compressed sparse row (CSR), compress sparse column (CSC), etc.). The tensor cores 1971 also include support for compressed sparse matrix representations in the event that the sparse matrix representation may be further compressed. Compressed, encoded, and/or compressed and encoded matrix data, along with associated compression and/or encoding metadata, can be read by the tensor cores 1971 and the non-zero values can be extracted. For example, for a given input matrix A, a non-zero value can be loaded from the compressed and/or encoded representation of at least a portion of matrix A. Based on the location in matrix A for the non-zero value, which may be determined from index or coordinate metadata associated with the non-zero value, a corresponding value in input matrix B may be loaded. Depending on the operation to be performed (e.g., multiply), the load of the value from input matrix B may be bypassed if the corresponding value is a zero value. In some examples, the pairings of values for certain operations, such as multiply operations, may be pre-scanned by scheduler logic and only operations between non-zero inputs are scheduled. Depending on the dimensions of matrix A and matrix B and the operation to be performed, output matrix C may be dense or sparse. Where output matrix C is sparse and depending on the configuration of the tensor cores 1971, output matrix C may be output in a compressed format, a sparse encoding, or a compressed sparse encoding.

The ray tracing cores 1972 may accelerate ray tracing operations for both real-time ray tracing and non-real-time ray tracing implementations. In particular, the ray tracing cores 1972 may include ray traversal/intersection circuitry for performing ray traversal using bounding volume hierarchies (BVHs) and identifying intersections between rays and primitives enclosed within the BVH volumes. The ray tracing cores 1972 may also include circuitry for performing depth testing and culling (e.g., using a Z buffer or similar arrangement). In one implementation, the ray tracing cores 1972 perform traversal and intersection operations in concert with the image denoising techniques described herein, at least a portion of which may be executed on the tensor cores 1971. For example, the tensor cores 1971 may implement a deep learning neural network to perform denoising of frames generated by the raytracing cores 1972. However, the CPU(s) 1961, graphics cores 1970, and/or ray tracing cores 1972 may also implement all or a portion of the denoising and/or deep learning algorithms.

In addition, as described above, a distributed approach to denoising may be employed in which the GPU 1980 is in a computing device coupled to other computing devices over a network or high-speed interconnect. In this distributed approach, the interconnected computing devices may share neural network learning/training data to improve the speed with which the overall system learns to perform denoising for different types of image frames and/or different graphics applications.

The ray tracing cores 1972 may process all BVH traversal and/or ray-primitive intersections, saving the graphics cores 1970 from being overloaded with thousands of instructions per ray. For example, each ray tracing core 1972 includes a first set of specialized circuitry for performing bounding box tests (e.g., for traversal operations) and/or a second set of specialized circuitry for performing the ray-triangle intersection tests (e.g., intersecting rays which have been traversed). Thus, for example, the multi-core group 1965A can simply launch a ray probe, and the raytracing cores 1972 independently perform ray traversal and intersection and return hit data (e.g., a hit, no hit, multiple hits, etc.) to the thread context. The other cores 1970, 1971 are freed to perform other graphics or compute work while the ray tracing cores 1972 perform the traversal and intersection operations.

Optionally, each ray tracing core 1972 may include a traversal unit to perform BVH testing operations and/or an intersection unit which performs ray-primitive intersection tests. The intersection unit generates a “hit”, “no hit”, or “multiple hit” response, which it provides to the appropriate thread. During the traversal and intersection operations, the execution resources of the other cores (e.g., graphics cores 1970 and tensor cores 1971) are freed to perform other forms of graphics work.

In some examples described below, a hybrid rasterization/ray tracing approach is used in which work is distributed between the graphics cores 1970 and ray tracing cores 1972.

The ray tracing cores 1972 (and/or other cores 1970, 1971) may include hardware support for a ray tracing instruction set such as Microsoft's DirectX Ray Tracing (DXR) which includes a DispatchRays command, as well as ray-generation, closest-hit, any-hit, and miss shaders, which enable the assignment of unique sets of shaders and textures for each object. Another ray tracing platform which may be supported by the ray tracing cores 1972, graphics cores 1970 and tensor cores 1971 is Vulkan API (e.g., Vulkan version 1.1.85 and later). Note, however, that the underlying principles described herein are not limited to any particular ray tracing ISA.

In general, the various cores 1972, 1971, 1970 may support a ray tracing instruction set that includes instructions/functions for one or more of ray generation, closest hit, any hit, ray-primitive intersection, per-primitive and hierarchical bounding box construction, miss, visit, and exceptions. More specifically, some examples includes ray tracing instructions to perform one or more of the following functions:
Ray Generation—Ray generation instructions may be executed for each pixel, sample, or other user-defined work assignment.
Closest Hit—A closest hit instruction may be executed to locate the closest intersection point of a ray with primitives within a scene.
Any Hit—An any hit instruction identifies multiple intersections between a ray and primitives within a scene, potentially to identify a new closest intersection point.
Intersection—An intersection instruction performs a ray-primitive intersection test and outputs a result.
Per-primitive Bounding box Construction—This instruction builds a bounding box around a given primitive or group of primitives (e.g., when building a new BVH or other acceleration data structure).
Miss—Indicates that a ray misses all geometry within a scene, or specified region of a scene.
Visit—Indicates the child volumes a ray will traverse.
Exceptions—Includes various types of exception handlers (e.g., invoked for various error conditions).

In some examples the ray tracing cores 1972 may be adapted to accelerate general-purpose compute operations that can be accelerated using computational techniques that are analogous to ray intersection tests. A compute framework can be provided that enables shader programs to be compiled into low level instructions and/or primitives that perform general-purpose compute operations via the ray tracing cores. Exemplary computational problems that can benefit from compute operations performed on the ray tracing cores 1972 include computations involving beam, wave, ray, or particle propagation within a coordinate space. Interactions associated with that propagation can be computed relative to a geometry or mesh within the coordinate space. For example, computations associated with electromagnetic signal propagation through an environment can be accelerated via the use of instructions or primitives that are executed via the ray tracing cores. Diffraction and reflection of the signals by objects in the environment can be computed as direct ray-tracing analogies.

Ray tracing cores 1972 can also be used to perform computations that are not directly analogous to ray tracing. For example, mesh projection, mesh refinement, and volume sampling computations can be accelerated using the ray tracing cores 1972. Generic coordinate space calculations, such as nearest neighbor calculations can also be performed. For example, the set of points near a given point can be discovered by defining a bounding box in the coordinate space around the point. BVH and ray probe logic within the ray tracing cores 1972 can then be used to determine the set of point intersections within the bounding box. The intersections constitute the origin point and the nearest neighbors to that origin point. Computations that are performed using the ray tracing cores 1972 can be performed in parallel with computations performed on the graphics cores 1972 and tensor cores 1971. A shader compiler can be configured to compile a compute shader or other general-purpose graphics processing program into low level primitives that can be parallelized across the graphics cores 1970, tensor cores 1971, and ray tracing cores 1972.

Building larger and larger silicon dies is challenging for a variety of reasons. As silicon dies become larger, manufacturing yields become smaller and process technology requirements for different components may diverge. On the other hand, in order to have a high-performance system, key components should be interconnected by high speed, high bandwidth, low latency interfaces. These contradicting needs pose a challenge to high performance chip development.

Embodiments described herein provide techniques to disaggregate an architecture of a system on a chip integrated circuit into multiple distinct chiplets that can be packaged onto a common chassis. In some examples, a graphics processing unit or parallel processor is composed from diverse silicon chiplets that are separately manufactured. A chiplet is an at least partially packaged integrated circuit that includes distinct units of logic that can be assembled with other chiplets into a larger package. A diverse set of chiplets with different IP core logic can be assembled into a single device. Additionally the chiplets can be integrated into a base die or base chiplet using active interposer technology. The concepts described herein enable the interconnection and communication between the different forms of IP within the GPU. The development of IPs on different process may be mixed. This avoids the complexity of converging multiple IPs, especially on a large SoC with several flavors IPs, to the same process.

Enabling the use of multiple process technologies improves the time to market and provides a cost-effective way to create multiple product SKUs. For customers, this means getting products that are more tailored to their requirements in a cost effective and timely manner. Additionally, the disaggregated IPs are more amenable to being power gated independently, components that are not in use on a given workload can be powered off, reducing overall power consumption.

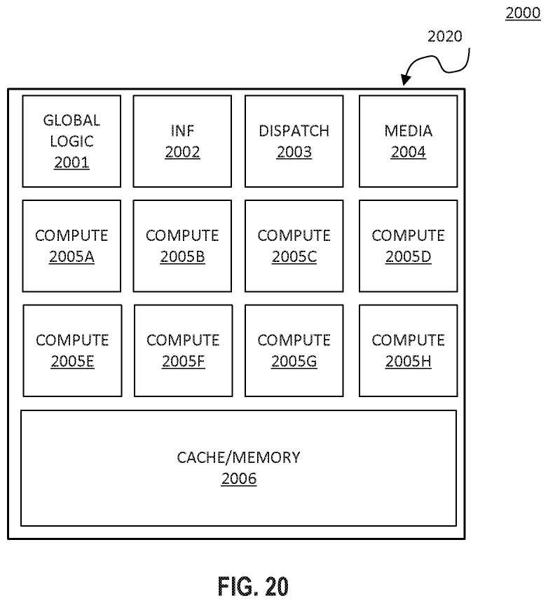

FIG. 20 shows a parallel compute system 2000, according to some examples. In some examples the parallel compute system 2000 includes a parallel processor 2020, which can be a graphics processor or compute accelerator as described herein. The parallel processor 2020 includes a global logic unit 2001, an interface 2002, a thread dispatcher 2003, a media unit 2004, a set of compute units 2005A-2005H, and a cache/memory units 2006. The global logic unit 2001, in some examples, includes global functionality for the parallel processor 2020, including device configuration registers, global schedulers, power management logic, and the like. The interface 2002 can include a front-end interface for the parallel processor 2020. The thread dispatcher 2003 can receive workloads from the interface 2002 and dispatch threads for the workload to the compute units 2005A-2005H. If the workload includes any media operations, at least a portion of those operations can be performed by the media unit 2004. The media unit can also offload some operations to the compute units 2005A-2005H. The cache/memory units 2006 can include cache memory (e.g., L3 cache) and local memory (e.g., HBM, GDDR) for the parallel processor 2020. Compute units 2005 may include units for one or more of a network or communication processor, a core, a graphics processor, a general purpose graphics processing unit (GPGPU), a neural-network processing unit (NPU), an embedded processor, a security processor, a cryptographic accelerator, a matrix accelerator, an in-memory analytics accelerator, a compression accelerator, a data streaming accelerator, or the like.

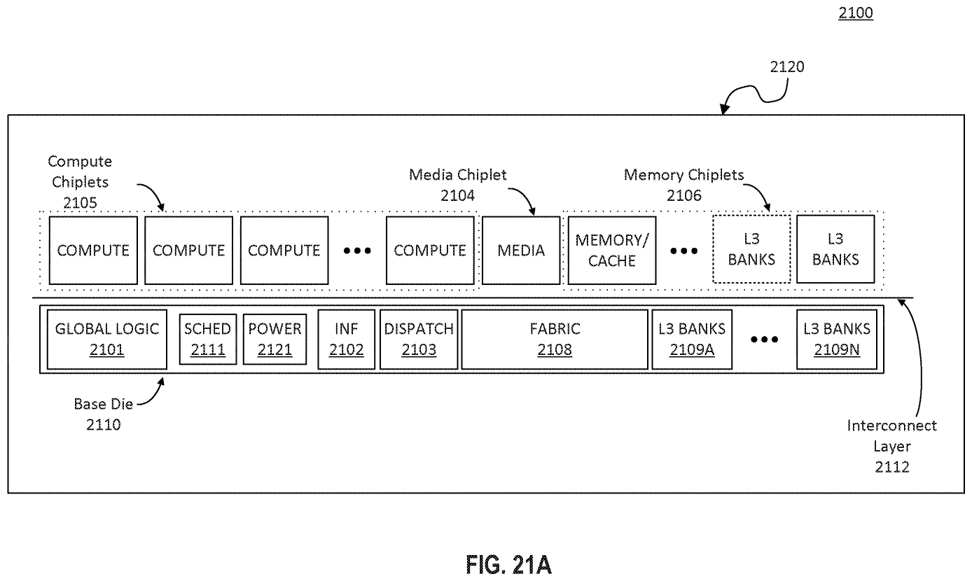

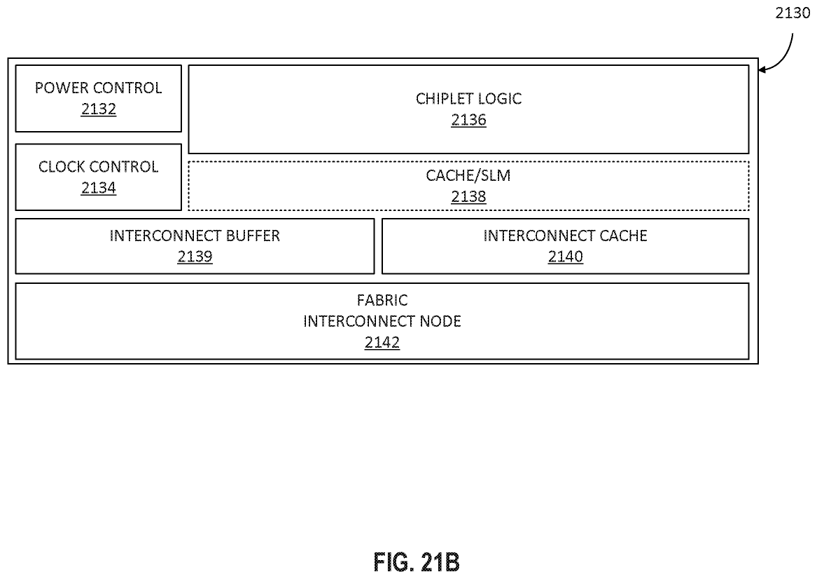

FIGS. 21A-21B illustrate a hybrid logical/physical view of a disaggregated parallel processor, according to examples described herein. FIG. 21A illustrates a disaggregated parallel compute system 2100. FIG. 21B illustrates a chiplet 2130 of the disaggregated parallel compute system 2100.

As shown in FIG. 21A, a disaggregated parallel compute system 2100 can include a parallel processor 2120 in which the various components of the parallel processor SOC are distributed across multiple chiplets. Each chiplet can be a distinct IP core that is independently designed and configured to communicate with other chiplets via one or more common interfaces. The chiplets include but are not limited to compute chiplets 2105, a media chiplet 2104, and memory chiplets 2106. Each chiplet can be separately manufactured using different process technologies. For example, compute chiplets 2105 may be manufactured using the smallest or most advanced process technology available at the time of fabrication, while memory chiplets 2106 or other chiplets (e.g., I/O, networking, etc.) may be manufactured using a larger or less advanced process technologies.

The various chiplets can be bonded to a base die 2110 and configured to communicate with each other and logic within the base die 2110 via an interconnect layer 2112. In some examples, the base die 2110 can include global logic 2101, which can include scheduler 2111 and power management 2121 logic units, an interface 2102, a dispatch unit 2103, and an interconnect fabric 2108 coupled with or integrated with one or more L3 cache banks 2109A-2109N. The interconnect fabric 2108 can be an inter-chiplet fabric that is integrated into the base die 2110. Logic chiplets can use the fabric 2108 to relay messages between the various chiplets. Additionally, L3 cache banks 2109A-2109N in the base die and/or L3 cache banks within the memory chiplets 2106 can cache data read from and transmitted to DRAM chiplets within the memory chiplets 2106 and to system memory of a host.

In some examples the global logic 2101 is a microcontroller that can execute firmware to perform scheduler 2111 and power management 2121 functionality for the parallel processor 2120. The microcontroller that executes the global logic can be tailored for the target use case of the parallel processor 2120. The scheduler 2111 can perform global scheduling operations for the parallel processor 2120. The power management 2121 functionality can be used to enable or disable individual chiplets within the parallel processor when those chiplets are not in use.

The various chiplets of the parallel processor 2120 can be designed to perform specific functionality that, in existing designs, would be integrated into a single die. A set of compute chiplets 2105 can include clusters of compute units (e.g., execution units, streaming multiprocessors, etc.) that include programmable logic to execute compute or graphics shader instructions. A media chiplet 2104 can include hardware logic to accelerate media encode and decode operations. Memory chiplets 2106 can include volatile memory (e.g., DRAM) and one or more SRAM cache memory banks (e.g., L3 banks).

As shown in FIG. 21B, each chiplet 2130 can include common components and application specific components. Chiplet logic 2136 within the chiplet 2130 can include the specific components of the chiplet, such as an array of streaming multiprocessors, compute units, or execution units described herein. The chiplet logic 2136 can couple with an optional cache or shared local memory 2138 or can include a cache or shared local memory within the chiplet logic 2136. The chiplet 2130 can include a fabric interconnect node 2142 that receives commands via the inter-chiplet fabric. Commands and data received via the fabric interconnect node 2142 can be stored temporarily within an interconnect buffer 2139. Data transmitted to and received from the fabric interconnect node 2142 can be stored in an interconnect cache 2140. Power control 2132 and clock control 2134 logic can also be included within the chiplet. The power control 2132 and clock control 2134 logic can receive configuration commands via the fabric can configure dynamic voltage and frequency scaling for the chiplet 2130. In some examples, each chiplet can have an independent clock domain and power domain and can be clock gated and power gated independently of other chiplets.

At least a portion of the components within the illustrated chiplet 2130 can also be included within logic embedded within the base die 2110 of FIG. 21A. For example, logic within the base die that communicates with the fabric can include a version of the fabric interconnect node 2142. Base die logic that can be independently clock or power gated can include a version of the power control 2132 and/or clock control 2134 logic.

Thus, while various examples described herein use the term SOC to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various examples of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”).”

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

### IP Core Implementations

One or more aspects of at least some examples may be implemented by representative code stored on a machine-readable medium which represents and/or defines logic within an integrated circuit such as a processor. For example, the machine-readable medium may include instructions which represent various logic within the processor. When read by a machine, the instructions may cause the machine to fabricate the logic to perform the techniques described herein. Such representations, known as “IP cores,” are reusable units of logic for an integrated circuit that may be stored on a tangible, machine-readable medium as a hardware model that describes the structure of the integrated circuit. The hardware model may be supplied to various customers or manufacturing facilities, which load the hardware model on fabrication machines that manufacture the integrated circuit. The integrated circuit may be fabricated such that the circuit performs operations described in association with any of the examples described herein.

References to “some examples,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Examples include, but are not limited to:
1. A method comprising:
   determining a memory split between a kev-value (KV) cache and weights for memory of a first type to be used by a machine learning model based, at least in part, on a total amount of available memory of the first type for the machine learning model and an indication of which layer of the machine learning model is to execute using an accelerator;
   migrating a first proper subset of data of the KV cache and weights according to the determined memory split into the memory of the first type and a second proper subset of data of KV cache and weights out of the memory of the first type;
   processing at least one token using the machine learning model; and
   updating the indication of which layer of the machine learning model is to execute.
2. The method of example 1, wherein the machine learning model is attention-based.
3. The method of any of examples 1-2, wherein the memory of the first type is volatile memory and the memory of the second type is non-volatile memory.
4. The method of any of examples 1-2, wherein the KV cache is to occupy a larger portion of the memory of the first type after migration.
5. The method of example 4, wherein data for the KV cache is prefetched from the memory of the second type.
6. The method of example 5, wherein the prefetch is performed based on at least one hints or access patterns.
7. A method comprising:
   receiving a request to perform vector database lookup for a query;
   performing the vector database lookup by:
      sampling a candidate set of nodes to select a plurality of nodes of the vector database to evaluate,
      for neighbor nodes of the selected plurality of nodes not in memory of a first type, prefetching the neighbors into the memory of the first type from memory of a second type,
      evaluating the neighbors in the memory of the first type by performing a dot product between the selected node(s) and their neighbors irrespective of order in the candidate set of nodes, and
      updating the candidate set in-order based on the dot products; and returning the candidate set.
8. The method of example 7, wherein the vector database is stored in non-volatile memory.
9. The method of any of examples 7-8, wherein the dot product is performed as a part of a distance calculation.
10. The method of example 9, wherein the distance calculation is one of cosine similarity or Euclidean distance.
11. The method of any of examples 7-10, wherein the vector database lookup is a part of a retrieval augmented generation.
12. The method of any of examples 7-11, wherein the memory of the first type is volatile memory and the memory of the second type is non-volatile memory.
13. A system comprising:
   compute hardware including at least one accelerator and at least one central processing unit (CPU);
   memory of a first type to store one or more of a machine learning model including at least a proper subset of a key-value (KV) cache and weights, a machine learning model memory manager, and/or a vector database search module; and
   memory of a second type to store one or more of at least a proper subset of the KV cache and weights of the machine learning model and/or the vector database, wherein the machine learning model memory manager is to determine and implement a memory split between the memory of the first type and the memory of the second type for the KV cache and weights of the machine learning model and the vector database search module is to perform an opportunistic, out-of-order vector database lookup upon receiving a vector database request.
14. The system of example 13, wherein the machine learning model memory manager is to determine and implement a memory split between the memory of the first type and the memory of the second type for the KV cache and weights of the machine learning model by:
   determining a memory split between the KV cache and weights for memory of the first type to be used by a machine learning model based, at least in part, on a total amount of available memory of the first type for the machine learning model and an indication of which layer of the machine learning model is to execute;
   migrating a first proper subset of data of the KV cache and weights according to the determined memory split into the memory of the first type and a second proper subset of data of KV cache and weights out of the memory of the first type;
   processing at least one token using the machine learning model; and
   updating the indication of which layer of the machine learning model is to execute.
15. The system of example 14, wherein the machine learning model is attention-based.
16. The system of example 14, wherein the memory of the first type is volatile memory and the memory of the second type is non-volatile memory.
17. The system of example 14, wherein the KV cache is to occupy a larger portion of the memory of the first type after migration.
18. The system of any of examples 13-17, vector database search module is to perform an opportunistic, out-of-order vector database lookup upon receiving a vector database request by:
   sampling a candidate set of nodes to select a plurality of nodes of the vector database to evaluate,
   for neighbor nodes of the selected plurality of nodes not in memory of a first type, prefetching the neighbors into the memory of the first type from memory of a second type,
   evaluating the neighbors in the memory of the first type by performing a dot product between the selected node(s) and their neighbors irrespective of order in the candidate set of nodes, and
   updating the candidate set in-order based on the dot products; and returning the candidate set.
19. The system of example 18, wherein the dot product is performed as a part of a distance calculation.
20. The system of example 18, wherein the vector database lookup is a part of a retrieval augmented generation.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. A method comprising:
determining a memory split between a kev-value (KV) cache and weights for memory of a first type to be used by a machine learning model based, at least in part, on a total amount of available memory of the first type for the machine learning model and an indication of which layer of the machine learning model is to execute using an accelerator;
migrating a first proper subset of data of the KV cache and weights according to the determined memory split into the memory of the first type and a second proper subset of data of KV cache and weights out of the memory of the first type;
processing at least one token using the machine learning model; and
updating the indication of which layer of the machine learning model is to execute.

2. The method of claim 1, wherein the machine learning model is attention-based.

3. The method of claim 1, wherein the memory of the first type is volatile memory and the memory of the second type is non-volatile memory.

4. The method of claim 1, wherein the KV cache is to occupy a larger portion of the memory of the first type after migration.

5. The method of claim 4, wherein data for the KV cache is prefetched from the memory of the second type.

6. The method of claim 5, wherein the prefetch is performed based on at least one hints or access patterns.

7. A method comprising:
receiving a request to perform vector database lookup for a query;
performing the vector database lookup by:
sampling a candidate set of nodes to select a plurality of nodes of the vector database to evaluate,
for neighbor nodes of the selected plurality of nodes not in memory of a first type, prefetching the neighbors into the memory of the first type from memory of a second type,
evaluating the neighbors in the memory of the first type by performing a dot product between the selected node(s) and their neighbors irrespective of order in the candidate set of nodes, and
updating the candidate set in-order based on the dot products; and returning the candidate set.

8. The method of claim 7, wherein the vector database is stored in non-volatile memory.

9. The method of claim 7, wherein the dot product is performed as a part of a distance calculation.

10. The method of claim 9, wherein the distance calculation is one of cosine similarity or Euclidean distance.

11. The method of claim 7, wherein the vector database lookup is a part of a retrieval augmented generation.

12. The method of claim 7, wherein the memory of the first type is volatile memory and the memory of the second type is non-volatile memory.

13. A system comprising:
compute hardware including at least one accelerator and at least one central processing unit (CPU);
memory of a first type to store one or more of a machine learning model including at least a proper subset of a key-value (KV) cache and weights, a machine learning model memory manager, and/or a vector database search module; and
memory of a second type to store one or more of at least a proper subset of the KV cache and weights of the machine learning model and/or the vector database, wherein the machine learning model memory manager is to determine and implement a memory split between the memory of the first type and the memory of the second type for the KV cache and weights of the machine learning model and the vector database search module is to perform an opportunistic, out-of-order vector database lookup upon receiving a vector database request.

14. The system of claim 13, wherein the machine learning model memory manager is to determine and implement a memory split between the memory of the first type and the memory of the second type for the KV cache and weights of the machine learning model by:
determining a memory split between the KV cache and weights for memory of the first type to be used by a machine learning model based, at least in part, on a total amount of available memory of the first type for the machine learning model and an indication of which layer of the machine learning model is to execute;
migrating a first proper subset of data of the KV cache and weights according to the determined memory split into the memory of the first type and a second proper subset of data of KV cache and weights out of the memory of the first type;
processing at least one token using the machine learning model; and
updating the indication of which layer of the machine learning model is to execute.

15. The system of claim 14, wherein the machine learning model is attention-based.

16. The system of claim 14, wherein the memory of the first type is volatile memory and the memory of the second type is non-volatile memory.

17. The system of claim 14, wherein the KV cache is to occupy a larger portion of the memory of the first type after migration.

18. The system of claim 13, vector database search module is to perform an opportunistic, out-of-order vector database lookup upon receiving a vector database request by:
sampling a candidate set of nodes to select a plurality of nodes of the vector database to evaluate,
for neighbor nodes of the selected plurality of nodes not in memory of a first type, prefetching the neighbors into the memory of the first type from memory of a second type,
evaluating the neighbors in the memory of the first type by performing a dot product between the selected node(s) and their neighbors irrespective of order in the candidate set of nodes, and
updating the candidate set in-order based on the dot products; and returning the candidate set.

19. The system of claim 18, wherein the dot product is performed as a part of a distance calculation.

20. The system of claim 18, wherein the vector database lookup is a part of a retrieval augmented generation.
